(19) United States
(12) Patent Application Publication
(10) Pub. No.: US 2013/0306565 A1
(43) Pub. Date: Nov. 21, 2013

(54) Electrochemical Ion Exchange Water Treatment

(71) Applicant: Jake Davis, Tucson, AZ (US)

(72) Inventor: Jake Davis, Tucson, AZ (US)

(21) Appl. No.: 13/675,887

(22) Filed: Nov. 13, 2012

Related U.S. Application Data
(60) Provisional application No. 61/558,391, filed on Nov. 10, 2011.

(51) Int. Cl. C02F 1/42

(52) U.S. Cl. CPC C02F 1/42
USPC 210/675; 210/190

(57) ABSTRACT

An apparatus for treating water, comprising an electrochemical cell; and at least one ion exchange container in fluid communication with said electrochemical cell.

### CROSS-REFERENCE TO RELATED APPLICATIONS

This application is a Non-Provisional application claiming priority from a U.S. Provisional Application having Ser. No. 61/558,391 filed Nov. 10, 2011, which is incorporated by reference herein.

### TECHNICAL FIELD

The present invention relates to a system and method for water treatment and, more particularly, to a system and method for removing impurities from water, and most particularly, to a system and method for removing impurities from water using ion exchange media and an electrochemical cell, which produces a quantity of acid and a quantity of base from the water to regenerate the ion exchange media.

### BACKGROUND ART

Water softening processes serve to remove divalent (e.g., Ba²⁺, Ca²⁺, Mg²⁺, Fe²⁺, Cu²⁺, etc.) and trivalent (e.g., Fe³⁺, Al³⁺, etc.) cations from aqueous solutions. The ions react with soaps and detergents to form precipitates (i.e., soap scum), which hamper the ability of the soaps and detergents to lather. The ions may also form mineral scale in pipes and on heat transfer surfaces. Calcium, magnesium and barium are the most ubiquitous hardness ions because the trivalent cations are not very soluble in water under conditions relevant to potable or industrial water supplies. Hard water is not suitable for many industrial, commercial, and residential applications due to the scale formed by barium, calcium and magnesium carbonate minerals on heat transfer surfaces, membrane filters, valves, pipe fixtures, and other surfaces.

The two most common methods of water softening are ion exchange and lime-soda ash precipitation. Ion exchange softening employs ion exchange resins or fibers that contain organic polymers with carboxylate (—COO⁻) or sulfonate (−SO₃⁻) anionic functional groups. Hard water is passed through a bed of ion exchange material in which the anionic functional groups are paired with a hydrogen ion (H⁺) or an alkali cation (e.g., or K⁺). As the hard water passes through the ion exchange media, divalent (and trivalent) cations are exchanged for monovalent cations. Once the ion exchange material's capacity for divalent cations is exhausted, it is regenerated with a concentrated solution of a monovalent salt or mineral acid (e.g., NaCl, HCl, H₂SO₄, etc.).

The primary disadvantages of ion exchange softening are associated with regeneration of the media. Regeneration requires a highly concentrated regenerant solution. A typical sulfonic acid ion exchange material is regenerated with ten to twelve pounds of sodium chloride per cubic foot of ion exchange media. The disposal and replacement of spent regenerant solution is expensive. Disposal of the spent brine solution leads to increased municipal water treatment costs and is detrimental to the environment because it contributes to the salinification of the water supply.

In the lime-soda ash process, water is softened by first raising its pH via addition of lime (CaO or Ca(OH)₂). Soda ash (Na₂CO₃) is then added to provide a source of carbonate ions (CO₃²⁻). The carbonate ions combine with the hardness ions to produce mixed carbonate mineral solids. Additionally, Mg²⁺ ions form Mg(OH)₂ solids under the high pH conditions. The precipitates formed in the high pH solutions are separated from the treated water via gravity settling or mechanical separation. The pH of the softened water is then lowered via addition of acid or by purging the solution with air or carbon dioxide gas. The main drawback to this process is that it requires the addition of chemicals and the solid-liquid separation process produces a high water content sludge that must be dewatered before disposal. Furthermore, the addition of chemicals to the water is costly and increases salinity.

A third but rarely used method of water softening employs a fluidized bed reactor wherein the hardness ions are crystallized as mixed carbonate mineral solids. The reactor is maintained at a high pH via the addition of NaOH, NaHCO₃, Na₂CO₃ or lime. The high pH of the solution promotes crystallization of mixed carbonate minerals on seed materials in the reactor. The solids are then separated from the softened water via filtration or gravity settling. The high pH of the softened water is then lowered via acid addition or purging the solution with air or carbon dioxide gas. One drawback of this process is the addition of chemicals, resulting in an increase in salinity.

As such, it would be an advance in the state of the art to provide a water treatment system that is capable of generating softened and deionized water with reduced total solids (i) that avoids the fouling problems present in existing electrochemical systems, (ii) that has substantially less loss of energy due to ohmic power dissipation than existing systems, (iii) that does not require the periodic addition of regeneration material, which results in a brine that must subsequently be disposed of, (iv) that does not increase the salt content of the treated water, and (v) that does not require the use of highly concentrated acids and bases.

### BRIEF DESCRIPTION OF THE DRAWINGS

The invention will be more fully understood by referring to the following Detailed Description of Specific Embodiments in conjunction with the Drawings, of which:

FIG. 1 is a schematic of one embodiment of Applicant's water treatment system that operates at the same pressure as the water supply;

FIG. 2A illustrates electrochemical reactions and movement of ions within one embodiment of a three-chamber electrochemical cell used in various embodiments of Applicant's water treatment system;

FIG. 2B illustrates a second embodiment of Applicant's electrochemical cell;

FIG. 2C illustrates a third embodiment of Applicant's electrochemical cell;

FIG. 2D illustrates a fourth embodiment of Applicant's electrochemical cell;

FIG. 2E illustrates a fifth embodiment of Applicant's electrochemical cell;

FIG. 2F illustrates a sixth embodiment of Applicant's electrochemical cell;

FIG. 3 is a schematic of one embodiment of Applicant's water treatment system that produces no liquid waste;

FIGS. 4(a) and 4(b) is a drawing illustrating the reactions on the surface of the weak acid ion exchange fibers initially loaded with alkali cations;

FIGS. 5(a) and 5(b) is a drawing illustrating the reactions on the surface of the weak acid ion exchange fibers initially loaded with divalent cations;

FIGS. 6(a)-6(c) is a drawing illustrating the reactions on the surface of the weak acid ion exchange fibers initially loaded with hydrogen ions;

FIG. 7 is a schematic showing an exemplary procedure for regenerating the ion exchange containers of the embodiment in FIG. 1;

FIG. 8 is a schematic of another embodiment of Applicant's water treatment system that operates at a different pressure than the water supply;

FIG. 9 is a schematic of one embodiment of Applicant's water treatment system with an integrated control system;

FIG. 10 is an example diagram depicting the electrochemical reactions and movement of ions within one embodiment of a two-chamber electrochemical cell used in various embodiments of Applicant's water treatment system;

FIGS. 11(a)-11(d) are diagrams depicting multiple flow configurations for the three-chamber electrochemical cell used in various embodiments of Applicant's water treatment system;

FIG. 12 is a schematic showing one configuration allowing three ion exchange containers to be effectively rotated in the system by a control system;

FIG. 13 is a schematic of another embodiment of Applicant's water treatment system that utilizes reverse osmosis filters;

FIG. 14 is a schematic of one embodiment of Applicant's water treatment system that utilizes both weak acid cation exchange containers and weak base anion exchange containers;

FIG. 15 is a schematic of another embodiment of Applicant's water treatment system that utilizes both weak acid cation exchange containers and weak base anion exchange containers;

FIG. 16 is a schematic of a variation of the embodiment of Applicant's water treatment system in FIG. 13;

FIG. 17 is an embodiment of Applicant's water treatment system that utilizes a crystallization chamber, the two-chamber electrochemical cell of FIG. 10, and two ion exchange containers; and

FIG. 18 is a flowchart describing one embodiment of a method of using Applicant's water treatment system;

FIG. 19 is a schematic of one embodiment of Applicant's water treatment system using x-port valves in a first flow configuration;

FIG. 20 is a schematic of the embodiment of FIG. 19 with the x-port valves in a second flow configuration;

FIG. 21 is a schematic of one embodiment of Applicant's water treatment system with a reverse osmosis unit to provide an ion boost;

FIG. 22 is a schematic of one embodiment of Applicant's water treatment system using x-port valves in a first configuration and having an electrochemical cell configured to alternate polarity;

FIG. 23 is a schematic of the embodiment of FIG. 22 with the x-port valves in a second flow configuration; and

FIG. 24 is a schematic of one embodiment of Applicant's water treatment system having a three-chamber electrochemical cell and a liquid/gas contactor;

FIG. 25 is a schematic of one embodiment of Applicant's water treatment system with a liquid/gas contactor.

### DETAILED DESCRIPTION OF SPECIFIC EMBODIMENTS

This invention is described in preferred embodiments in the following description with reference to the FIGs., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

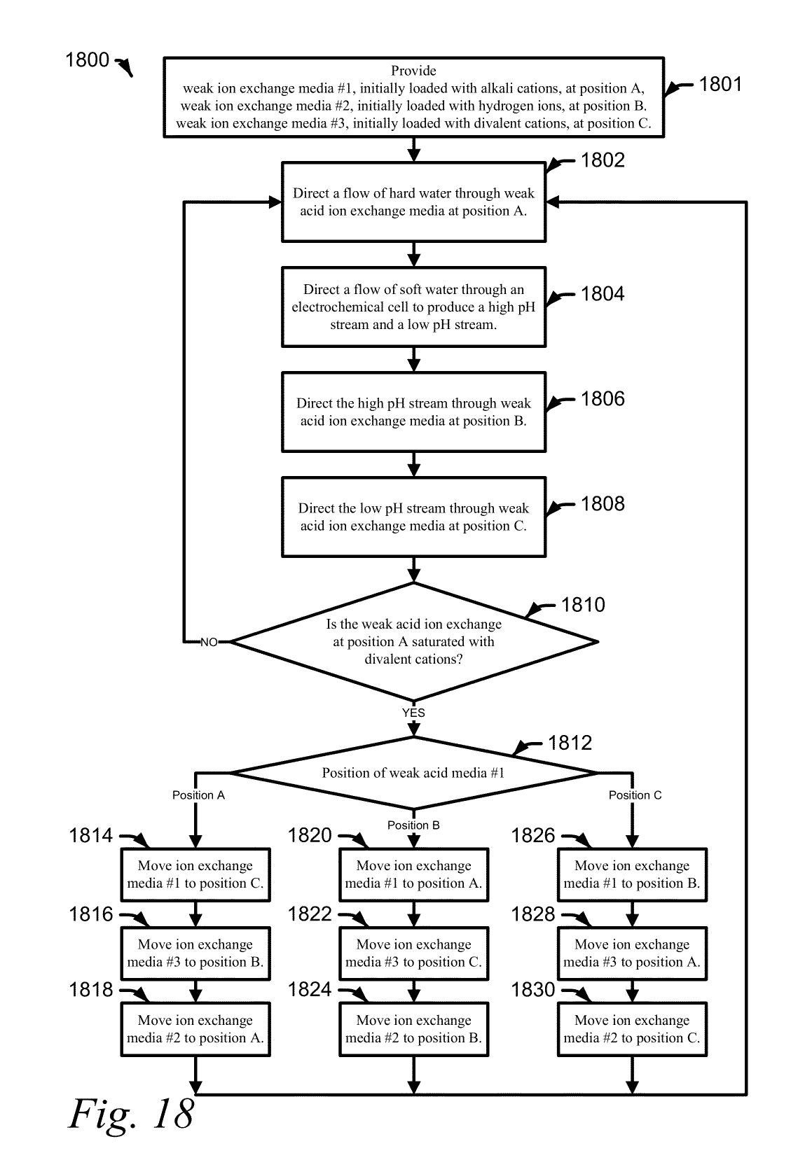

The schematic flow chart diagrams included are generally set forth as logical flow-chart diagrams (e.g., FIG. 18). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIG. 18). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Applicant's water treatment system is capable of treating hard water to produce softened and deionized water. Applicant's system softens water by passing it over an ion exchange media. An electrochemical cell is used to generate high and low pH water from the softened water. The high and low pH water is used to regenerate the ion exchange media once it becomes saturated with hard water (divalent mineral) cations. The regeneration process occurs in two steps: (i) substitute the divalent cations on the ion exchange media with hydrogen ions using a low pH stream and (ii) substitute the hydrogen ions on the ion exchange media with alkali cations using a high pH stream. The regeneration process also results in removal of a substantial portion of the ions from the water. This method of regeneration eliminates the need to add chemicals to the water as in other water softening systems. The necessary reagents are instead produced in situ by the electrochemical cell. Utilizing a weak acid ion exchange media permits regeneration at milder pH conditions (i.e., less acidic and less basic) than would be necessary with strong acid ion exchange media. The pH levels produced by the electrochemical cell at relatively low voltages are well within the regeneration pH conditions for the weak acid ion exchange media.

Various embodiments of Applicant's water treatment system and method described herein include one or more pumps. In different embodiments, the pumps are, without limitation, peristaltic, impeller, rotary, diaphragm, positive displacement, or a combination therein.

Various embodiments of Applicant's water treatment system and method described herein include one or more valves. In different embodiments, the valves may be manual or automated. In different embodiments, the automated valves may be driven by air (pneumatic), by fluid (hydraulic), by electricity (mechanical drive or solenoid), or by a combination therein. In different embodiments, the valves are, without limitation, ball, elliptic, stack, gate, globe, needle, butterfly, diaphragm, or a combination therein.

Various embodiments of Applicant's water treatment system and method described herein includes pipes. The term “pipe” may be any item that is capable of channeling or directing liquid. In different embodiments, the pipes may be rigid or flexible. In different embodiments, the pipes may be comprised of, without limitation, metal (such as steel, aluminum, copper, or a metal alloy), plastic (such as polyvinyl chloride, chlorinated polyvinyl chloride, fiber reinforced plastic, polypropylene, polyethylene, polytetrafluoroethylene, cross-linked high-density polyethylene, polybutylene, and acrylonitrile butadiene styrene), ceramic, silicone, fiberglass, or a combination therein.

While specific values for parameters are recited herein in the various embodiments of Applicant's water treatment system, it is to be understood that, within the scope of the invention, the values of these parameters may vary over wide ranges to suit different applications.

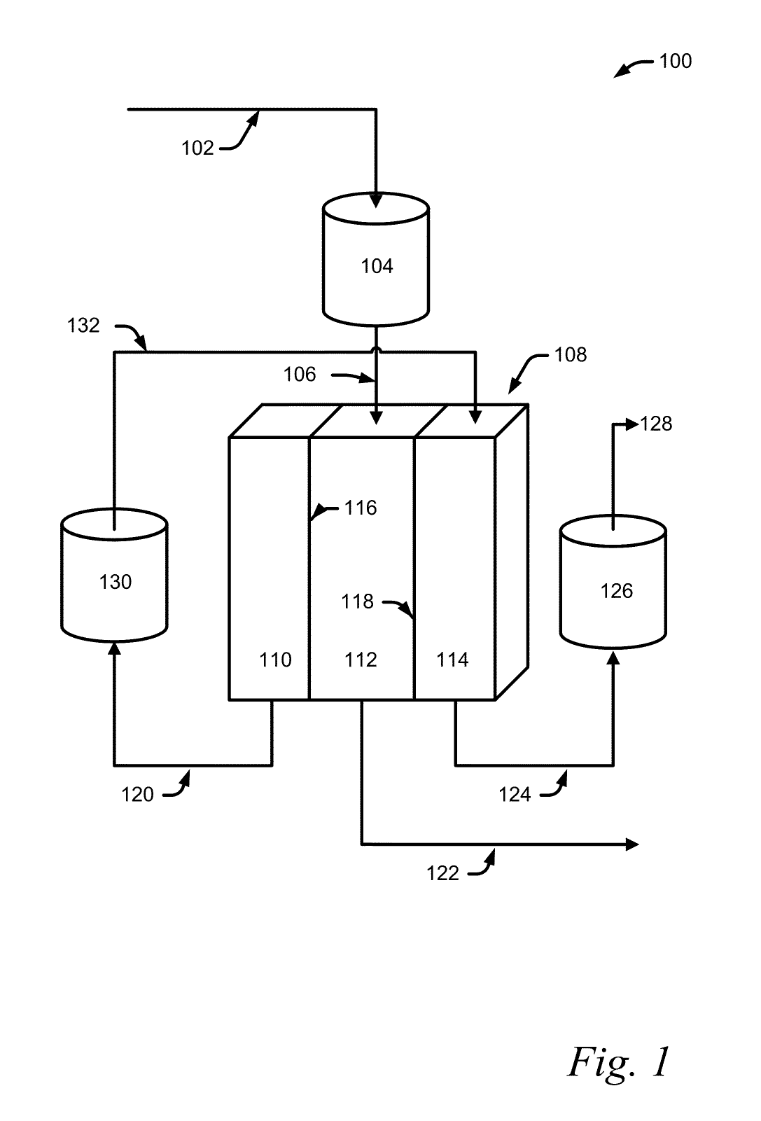

Referring to FIG. 1, a schematic of one embodiment of Applicant's water treatment system 100 is depicted. Hard water is fed into the system through pipe 102. Hard water has high dissolved mineral content. These minerals are generally in the form of calcium and magnesium divalent cations, Ca²⁺ and Mg²⁺, but may also be in the form of divalent and trivalent cations of other minerals, such as Ba²⁺, Sr²⁺, Fe², Cu²⁺, Fe³⁺, and Al³⁺. These cations are present in many water supplies and often lead to undesirable results. In domestic settings, these cations react with organic acids in soap and thus reduce the soap's effectiveness. In addition, these cations react with dissolved atmospheric carbon dioxide to form carbonates, such as CaCO₃ and MgCO₃. The carbonates can precipitate out of solution, forming scale in water heaters and in pipes, which may lead to clogging. In industrial settings, the scaling caused by these cations can have deleterious effects on boilers and cooling towers.

The hard water is fed into a container 104 comprising ion exchange media. In one embodiment, the ion exchange media in container 104 comprises ion exchange resin beads. In one embodiment, the beads comprise organic polymers containing weak acid cation exchange sites. In different embodiments, the polymer backbones containing the ion exchange functional groups are derived polystyrene, polyacrylic acid, polyacrylonitrile, polymethacrylate, polyethylene, polypropylene, or a combination thereof. In some embodiments, the resin beads comprise interconnected pores, which provide increased surface area for the ion exchange reactions.

In one embodiment, the ion exchange media in container 104 comprises ion exchange fibers. In some embodiments, the nominal dimension of the ion exchange fibers is approximately one tenth that of the ion exchange resin beads. As a result, the ion exchange fibers have, in comparison, faster mass transfer rates.

In one embodiment, the ion exchange media in container 104 is weak acid ion exchange fibers. The weak acid ion exchange fibers comprise weakly acidic functional groups. As a result of exhibiting faster mass transfer rates over resin beads, weak acid ion exchange fibers can be effectively regenerated at a significantly higher pH than traditional weak acid ion exchange resin beads. In one embodiment, the weak acid ion exchange media has carboxylic acid functional groups. In one embodiment, the ion exchange container 104 contains Fiban® K-4, Mion® K-5 or similar ion exchange fibers. In one embodiment, for ion exchange fibers having 5 millimole equivalents of ion exchange sites per gram of material and assuming 400 gallons/day water consumption with a divalent cation concentration of 1.5 millimole per liter, 906 grams of fiber are necessary for 1 container regeneration per day. In one embodiment, the container size is 4 L, based on fibers packed with a density of 0.23 grams/cm³, which is much smaller than a typical 113 L container for a conventional ion exchange water softening system. In one embodiment, the ion exchange container 104 contains a shallow shell resin with an inert core. In one embodiment, the ion exchange container 104 contains Purolite SST-104.

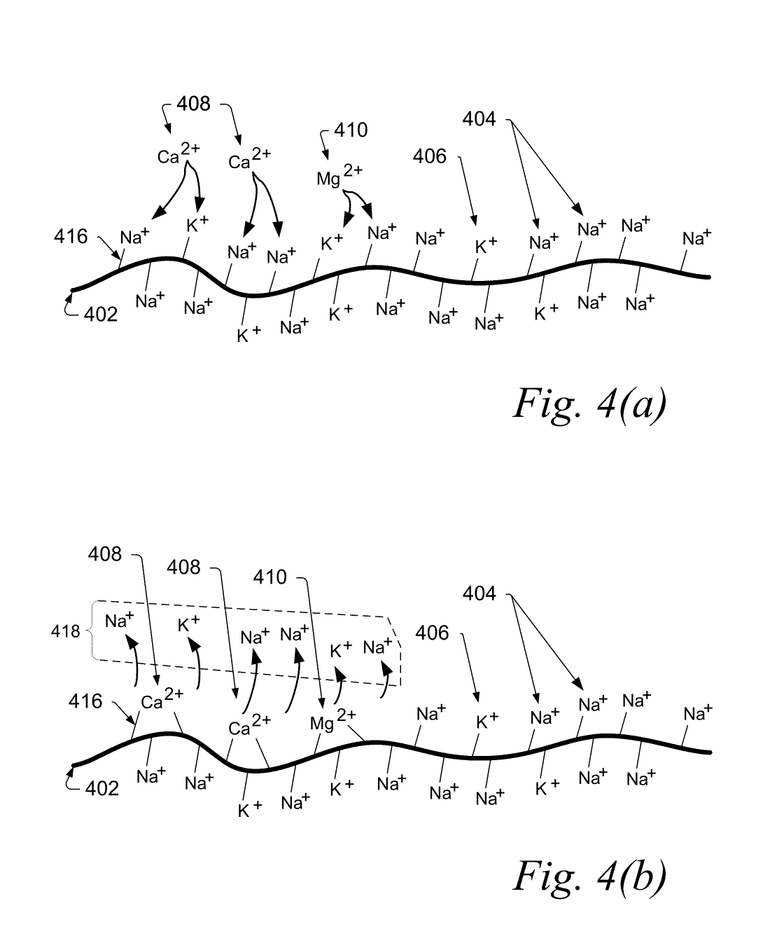

In one embodiment, the functional groups of the ion exchange media in ion exchange container 104 are initially loaded with alkali metal ions, such as sodium (Na⁺) or potassium (K⁺). The functional groups preferentially bind divalent cations, such as Ca²⁺, Mg²⁺, Ba²⁺, Sr²⁺, Fe²⁺, and Cu²⁺, over alkali metal cations. As such, the divalent cations in the hard water passing over the ion exchange media bind to the ion exchange media and the alkali metal ions are released into the water, as illustrated in FIGS. 4(a) and 4(b).

Referring to FIG. 4(a), an ion exchange fiber (402) having functional groups 416 initially loaded with the alkali metal ions sodium (404) and potassium (406) is shown. As a flow of hard water containing divalent cations calcium (408) and magnesium (410) passes over fiber 402, the divalent cations 408 and 410 replace sodium 404 and potassium 406 alkali metal ions. The divalent cations 408 and 410 have a +2 charge and will, as a result, each replace two alkali metal ions, each having a +1 charge, on the ion exchange media as illustrated by the double arrows in FIG. 4(a).

In certain embodiments, functional groups 416 comprise an alkali metal salt of pendent carboxylic acid groups. In certain embodiments, functional groups 416 comprise an alkali metal salt of pendent sulfonic acid groups.

Referring to FIG. 4(b), the ion exchange fiber (402) of FIG. 4(a) is shown after the exchange of divalent cations 408 and 410 for alkali metal ions 418. Divalent cations 408 and 410 are associated with the pendent functional groups 416 and alkali metal ions 418 are freed and released into solution.

Over time, substantially all of the alkali metal ions (404, 406) on the functional groups (416) of the ion exchange media in container 104 will be replaced with divalent cations (408 and 410). Once this saturation occurs, the ion exchange media must be regenerated.

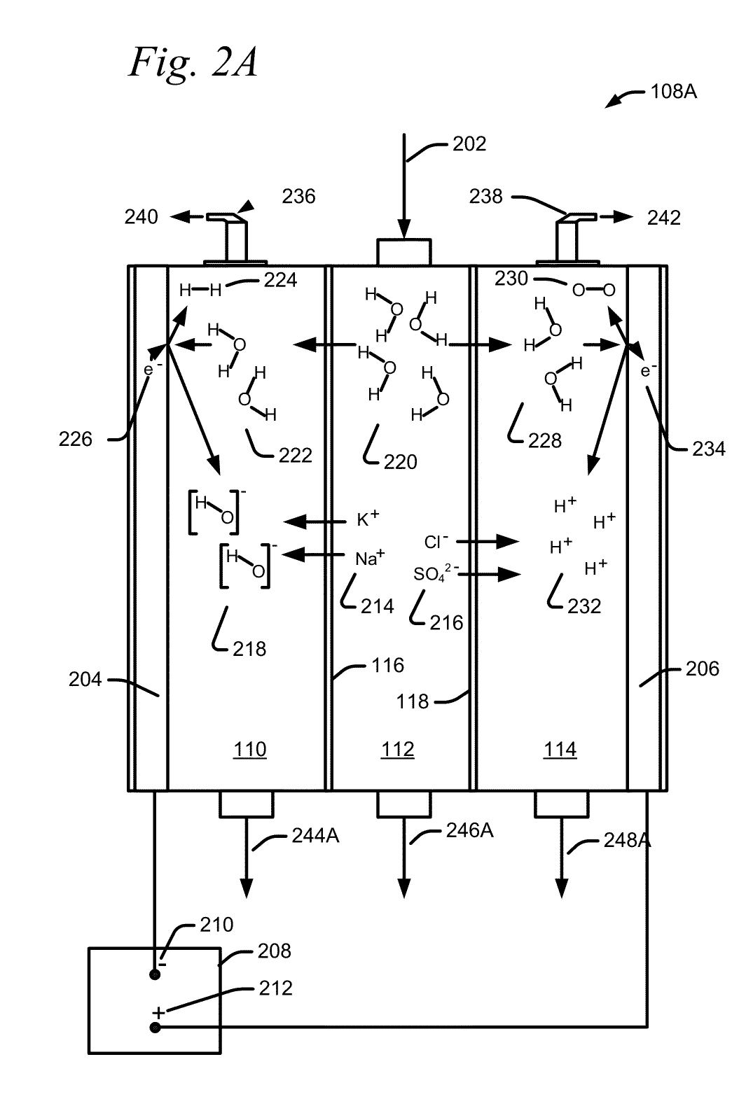

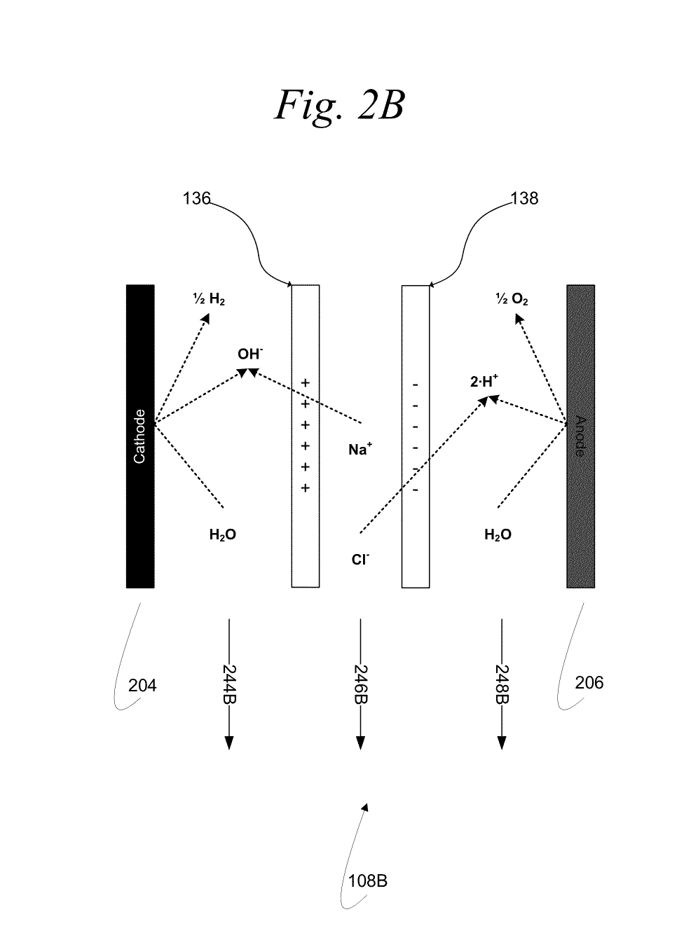

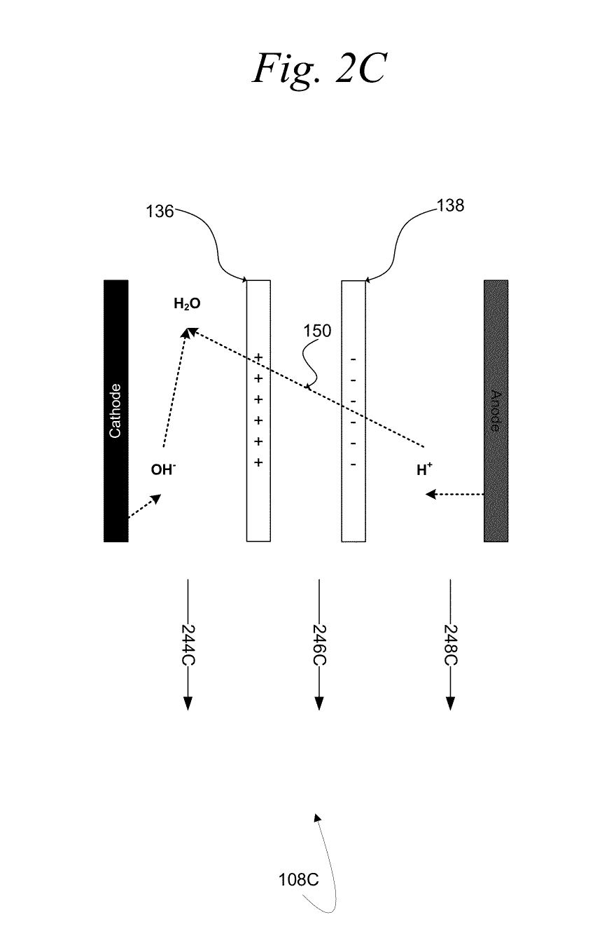

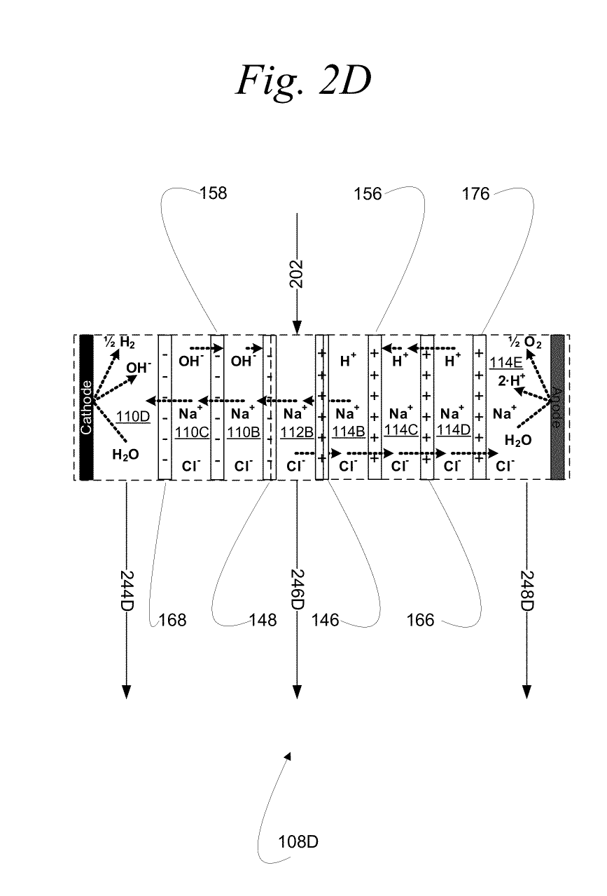

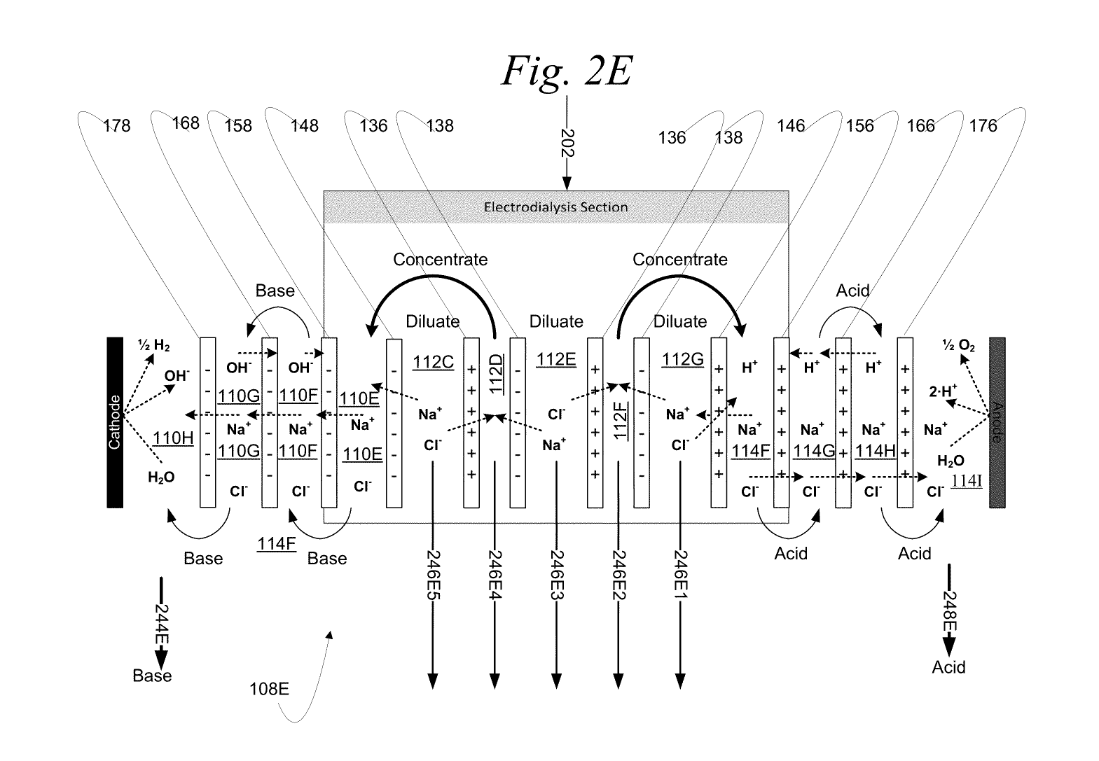

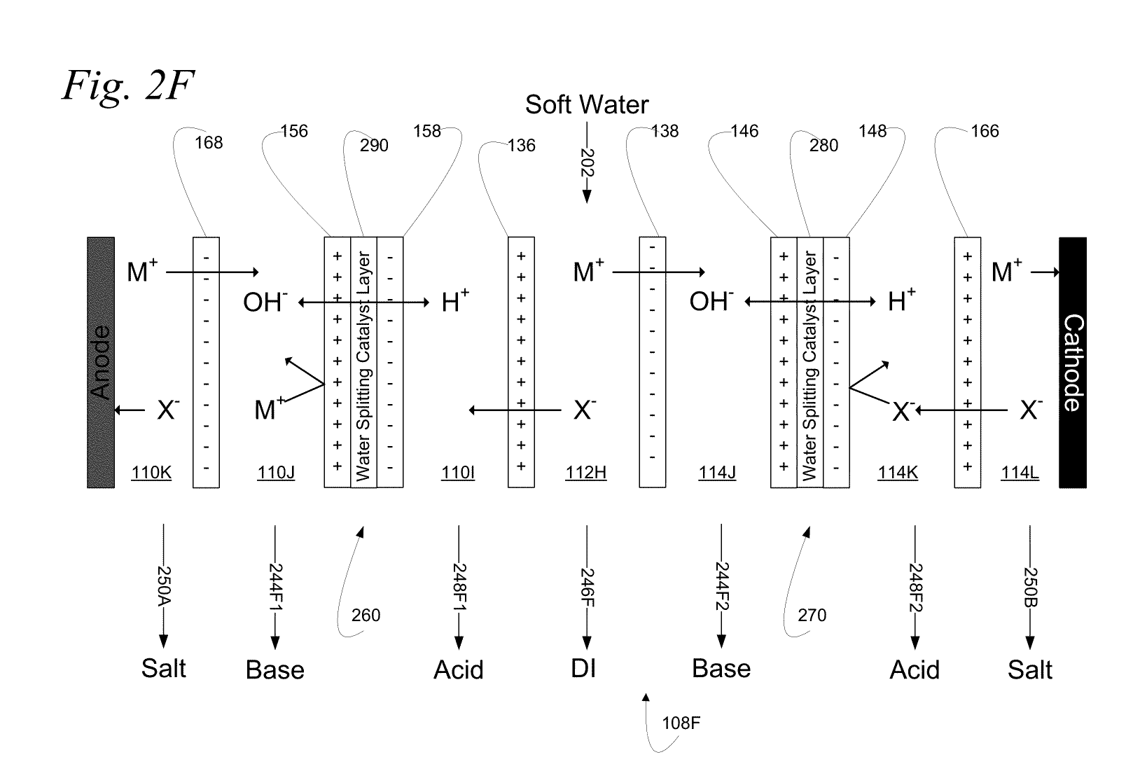

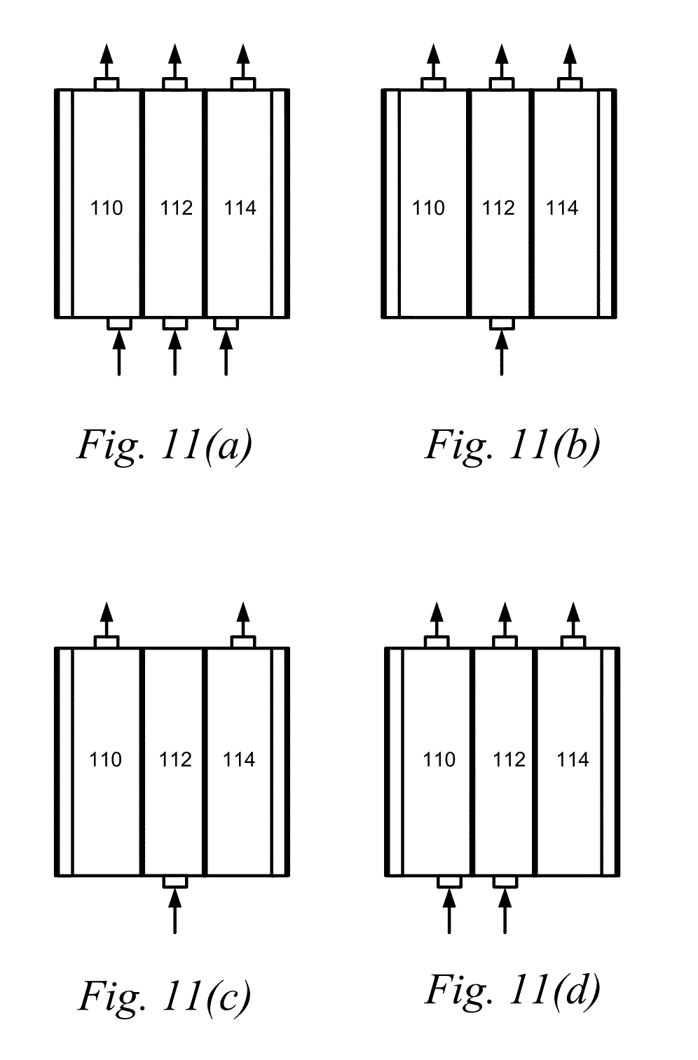

Referring again to FIG. 1, because ion exchange container 104 exchanged the divalent cations in the water with alkali metal ions, soft water exits ion exchange container 104 in pipe 106. Referring now to FIG. 2A, in certain embodiments the soft water in pipe 106 enters an electrochemical cell (108). In one embodiment, electrochemical cell 108 comprises three chambers 110, 112, and 114. In one embodiment, soft water enters the central chamber (112). In one embodiment, soft water enters one or more of chambers 110, 112, and 114, as illustrated in FIG. 11. Cathode chamber 110 is disposed on one side of central chamber 112. Cathode chamber 110 contains a cathode on the far side of the chamber opposite central chamber 112. Anode chamber 114 is disposed on the opposite side of central chamber 112. Anode chamber 114 contains an anode on the far side of the chamber opposite central chamber 112. The anode and cathode are electrically conductive electrodes. In different embodiments, the anode and cathode are comprised of a metal, metal alloy, graphite, conductive polymer, conductive composite, semiconductor, or a combination thereof.

Referring now to FIG. 2A, in one embodiment, cathode chamber 110 is separated from central chamber 112 by a water-permeable partition 116. The cathode 204, being negatively charged, generates an electric field that attracts the positively charged cations (primarily alkali metal ions) in the water toward the cathode. Pores in the partition 116 allow the cations and a portion of the water to pass from the central chamber 112 into cathode chamber 110.

The cathode 204 also reacts with water, resulting in electrolysis of the water into hydrogen gas (H₂) 224 and hydroxide ions (OH⁻) 218. The hydrogen gas will form bubbles and rise to the top of the cathode chamber 110. In one embodiment, the cathode chamber is sized so the downward flow of water is slow enough to allow the hydrogen bubbles to rise to the top of cathode chamber 110 for collection. The migration of cations from central chamber 112 into cathode chamber 110 balances the negative charge produced by the electrolysis reactions at the cathode.

In one embodiment, anode chamber 114 is separated from central chamber 112 by a partition 118. The anode 206, being positively charged, generates an electric field that attracts the negatively charged anions, primarily sulfate (SO₄²⁻) and chloride (Cl⁻) ions, in the water toward the anode. The pores in the partition 118 allow the anions and a portion of the water to pass from the central chamber 112 into anode chamber 114.

The anode 206 also reacts with water, resulting in electrolysis of the water into oxygen gas (O₂) 230 and protons (H⁺) 232. The oxygen gas will form bubbles and rise to the top of anode chamber 114. In one embodiment, the anode chamber is sized so the downward flow of water is slow enough to allow the oxygen bubbles to rise to the top of anode chamber 114 for collection. In one embodiment, the collected oxygen and hydrogen gas is used as fuel to offset the power consumed by the water treatment system (100). The migration of anions from central chamber 112 into anode chamber 114 balances the positive charge produced by the electrolysis reactions at the anode.

In one embodiment, partitions 116 and 118 are membranes that allow cations and anions, respectively, to pass freely from the central chamber 112 into the cathode chamber 110 and anode chamber 114, respectively, while restricting the flow of water. In different embodiments, the membrane comprises a polymer, such as polyolefin. In various embodiments, partitions 116 and 118 are plastic or ceramic plates with a ratio of surface to pore area of about 30% to about 75%.

The partitions 116 and 118 serve primarily to help segregate the vertical flow between the three chambers 110, 112, 114. In this embodiment, electrochemical cell 108 is configured to allow vertical flow of water without excessive mixing between chambers 110 and 112 and between chambers 112 and 114. In different embodiments, partitions 116 and 118 are comprised of ion exchange membranes, hydrophilic microporous polyethylene, hydrophilic expanded polytetrafluorethylene (ePTFE), polyethersulfone (PES), or polyolefin radiation grafted with acrylic acid.

In one embodiment, partitions 116 and 118 do not exist in electrochemical cell 108. As such, the interior of electrochemical cell 108 comprises a single large chamber. In this embodiment, electrochemical cell 108 is sufficiently large enough and configured such that the flow prevents excessive mixing between the flow in chamber 110 and the flow in chamber 112 and between the flow in chamber 112 and the flow in chamber 114.

While the anions and cations decrease the resistivity of water, the resistivity of the soft water in the electrochemical cell (108) will remain high enough to result in a substantial ohmic loss. Ohmic loss is the voltage drop between the anode and cathode due to the slow movement of the cations (anions) toward the cathode (anode). High ohmic loss increases the energy requirements and therefore increases the costs to run the system.

In one embodiment, the anode and cathode in the electrochemical cell (108), taking into account the resistivity of the water (i.e., amount of anions and cations), are spaced to maintain a voltage drop of less than 20 V. In one embodiment, the anode and cathode are spaced to maintain a voltage drop of less than 10 V. In one embodiment, a fraction of the ions in pipe 106 are concentrated by a membrane filter (not shown) prior to being fed into the electrochemical cell (108). In one embodiment, the interior space of each chamber 110, 112, and 114 is packed with ion exchange media containing both cationic and anionic exchange sites. The ion exchange media serves to maintain a high concentration of ions in each chamber of the electrochemical cell. High ion concentrations lead to high electrical conductivity and lower Ohmic power dissipation.

In one embodiment, the ion exchange media in electrochemical cell 108 comprises ion exchange beads. In one embodiment, the ion exchange media in electrochemical cell 108 comprises ion exchange fibers. In one embodiment, the ion exchange media in electrochemical cell 108 comprises weak acid ion exchange fibers. The ion exchange media also serves to substantially slow the flow of ions (more specifically, in one embodiment, alkali cations, chloride anions, and sulfate anions) through the electrochemical cell (108), providing sufficient time for the majority of ions to travel perpendicular to the flow of water and reach the cathode chamber (110) or the anode chamber (114) before exiting the electrochemical cell (108). In one embodiment, the faradic loss, which is the energy consumed in generating hydrogen at the cathode and oxygen at the anode of the electrochemical cell (108), is less than the ohmic loss between the cathode and anode of the electrochemical cell (108).

The pH in the cathode chamber (110) is increased by the production of hydroxide ions (OH⁻) at the cathode. In one embodiment, the pH in the cathode chamber (110) is about 13. In one embodiment, the pH in the cathode chamber (110) is between about 11 and about 14. The pH in the anode chamber (114) is decreased by the production of hydrogen ions (H⁺) at the anode. In one embodiment, the pH in the anode chamber (114) is about 1. In one embodiment, the pH in the anode chamber (114) is between about 0 and about 2. In one embodiment, the pH of the water in the central chamber (112) remains substantially unchanged from the pH water in pipe 106 feeding the electrochemical cell (108).

Water exits the central chamber 112 by way of pipe 246. The water in pipe 122 is soft because it contains no appreciable amounts of dissolved minerals in the form of divalent cations. The water in pipe 246 is not, however, fully deionized because not all of the alkali metal ions added in ion exchange container 104 have been removed in the electrochemical cell 108A of FIG. 2A. Thus, the water in output stream 246 comprises a first concentration of alkali metal cations. The water in pipe 246 is ready to be used for domestic or industrial purposes.

Porous diaphragms 116 and 118 are not maximally efficient at resisting proton migration. As a result, the proton concentration in portion 114 of electrochemical chamber 108A reaches an equilibrium level, and therefore, output stream 248 from device 108A can only achieve a first concentration of protons. Similarly, the output stream 244 from portion 110 of device 108A can only achieve a first concentration of hydroxide ions.

Referring now to FIG. 2B, the porous membranes 116 and 118 of assembly 108A (FIG. 2A) have been replaced with a cation membrane 138 and an anion exchange membrane 136, respectively. Anion exchange membrane 136 better resists proton migration than does porous membrane 118. As a result, output stream 248B from device 108B can achieve a second concentration of protons, wherein that second concentration of protons is greater than the first concentration of protons in stream 248 from device 108A. Similarly, the output stream 244B from portion 110 of device 108B can achieve a second concentration of hydroxide ions, wherein that second concentration of hydroxide ions is greater than the first concentration of hydroxide ions in stream 244 from device 108A.

Referring now to FIG. 2C, the device 108B (FIG. 2B) is modified to utilize a water splitting current 150.

Referring now to FIG. 2D, electrochemical device 108D receives input stream of soft water 202 which enters a central portion 112B. Central portion 112B is defined by an anion exchange membrane 146 and a cation exchange membrane 148. As those skilled in the art will appreciate, a cation exchange membrane comprises a permanent negative charge, i.e. negatively charged moieties are permanently affixed to the membrane backbone. On the other hand, an anion exchange membrane comprises a permanent positive charge, i.e. positively charged moieties are permanently affixed to the membrane backbone.

In device 108D, portion 110 of device 108A is subdivided into regions 110B, 110C, and 112D, which are defined by cation exchange membrane 148/cation exchange membrane 158, cation exchange membrane 158/cation exchange membrane 168, and cation exchange membrane 168/cathode 204. Cation exchange membranes 148, 158, and 168, facilitate the passage of alkali metal salts therethough but resist the flow of hydroxyl anions therethrough. Anion exchange membranes 146, 156, 166, and 176, facilitate the passage of halogen anions therethrough but resist the passage of protons therethrough.

Similarly in device 108D, portion 114 of device 108A is subdivided into regions 114B, 114C, 114D, and 114E, which are defined by anion exchange membrane 146/anion exchange membrane 156, anion exchange membrane 156/anion exchange membrane 166, anion exchange membrane 166/anion exchange membrane 176, and anion exchange membrane 176/anode 206.

The water in output stream 246D from device 108D comprises a second concentration of alkali metal salts, wherein the second concentration of alkali metal salts is less than the first concentration of alkali metal salts in output stream 246A from device 108A.

The water in output stream 244D from device 108D comprises a third concentration of hydroxide ions, wherein that third concentration of hydroxide ions is greater than the first concentration of hydroxide ions in output stream 244A from device 108A and greater than the second concentration of hydroxide ions in output stream 244B from device 108B.

The water in output stream 248D from device 108D comprises a third concentration of protons, wherein that third concentration of protons is greater than the first concentration of protons in output stream 248A from device 108A and greater than the second concentration of protons in output stream 248B from device 108B.

Referring now to FIG. 2E, electrochemical device 108E receives input stream of soft water 202 which enters a central portion comprising regions 112C, 112D, 112E, 112F, and 112G. Region 112C of device 108E is defined by an anion exchange membrane 136A and a cation exchange membrane 148A. Region 112D of device 108E is defined by cation exchange membrane 138A/anion exchange membrane 136A. Region 112E of device 108E is defined by cation exchange membrane 138A/anion exchange membrane 136B. Region 112F of device 108E is defined by cation exchange membrane 138b/anion exchange membrane 136b.

In device 108E, portion 110 of device 108A is subdivided into regions 110E, 110F, 110G, and 110 H, which are defined by cation exchange membrane 148/cation exchange membrane 158, cation exchange membrane 158/cation exchange membrane 168, cation exchange membrane 168/cation exchange membrane 178, and cation exchange membrane 178/cathode 204.

In device 108E, portion 114 of device 108A is subdivided into regions 114F, 114G, 114H, and 114I, which are defined by anion exchange membrane 146/anion exchange membrane 156, anion exchange membrane 156/anion exchange membrane 166, anion exchange membrane 166/anion exchange membrane 176, and anion exchange membrane 176/anode 206.

The water in output streams 246E1, 246E2, 246E3, 246E4. and 246E5, from device 108E comprises a third concentration of alkali metal salts, wherein the third concentration of alkali metal salts is less than the first concentration of alkali metal salts in output stream 246A from device 108A and less than the second concentration of alkali metal salts in output stream 246D from device 108D.

The water in output stream 244E from device 108E comprises a fourth concentration of hydroxide ions, wherein that fourth concentration of hydroxide ions is greater than the first concentration of hydroxide ions in output stream 244A from device 108A, and greater than the second concentration of hydroxide ions in output stream 244B from device 108B, and greater than the third concentration of hydroxide ions in output stream 244D from device 108D.

The water in output stream 248E from device 108E comprises a fourth concentration of protons, wherein that fourth concentration of protons is greater than the first concentration of protons in output stream 248A from device 108A, and greater than the second concentration of protons in output stream 248B from device 108B, and greater than the third concentration of protons in output stream 248D from device 108D.

Referring now to FIG. 2F, electrochemical device 108F receives input stream of soft water 202 which enters a central portion 112H. Central portion 112H of device 108F is defined by an anion exchange membrane 136 and a cation exchange membrane 138. Water in output stream 246F comprises deionized water.

In device 108F, portion 110I of device 108F is defined by a trilayer laminate assembly 260 comprising cation exchange membrane 158/water splitting layer 290/anion exchange membrane 156 and anion exchange membrane 136, wherein cation exchange membrane 158 has a facing relationship with anion exchange membrane 136. Output water from portion 110I in stream 248F1 comprises an acid having a fifth concentration of protons, wherein that fifth concentration of protons is greater than the first concentration of protons in output stream 248A from device 108A, and greater than the second concentration of protons in output stream 248B from device 108B, and greater than the third concentration of protons in output stream 248D from device 108D, and greater than the fourth concentration of protons in output stream 248E from device 108E.

In device 108F, portion 110J of device 108F is defined by a trilayer laminate assembly 260 comprising cation exchange membrane 158/water splitting layer 290/anion exchange membrane 156 and cation exchange membrane 168, wherein anion exchange membrane 156 has a facing relationship with cation exchange membrane 168. Output water from portion 110J in stream 244F1 comprises a base having a fifth concentration of hydroxide ions, wherein that fifth concentration of hydroxide ions is greater than the first concentration of hydroxide ions in output stream 248A from device 108A, and greater than the second concentration of hydroxide ions in output stream 248B from device 108B, and greater than the third concentration of hydroxide ions in output stream 248 D from device 108D, and greater than the fourth concentration of hydroxide ions in output stream 248E from device 108E.

In device 108F, portion 110K of device 108F is defined by cation exchange membrane 168 and anode 204. Output water from portion 110K in stream 250a comprises a salt solution.

In device 108F, portion 114J of device 108F is defined by a trilayer laminate assembly 270 comprising cation exchange membrane 148/water splitting layer 280/anion exchange membrane 146 and anion exchange membrane 146, wherein anion exchange membrane 146 has a facing relationship with cation exchange membrane 138. Output water from portion 114J in stream 244F2 comprises a base having a fifth concentration of hydroxide ions, wherein that fifth concentration of hydroxide ions is greater than the first concentration of hydroxide ions in output stream 248A from device 108A, and greater than the second concentration of hydroxide ions in output stream 248B from device 108B, and greater than the third concentration of hydroxide ions in output stream 248D from device 108D, and greater than the fourth concentration of hydroxide ions in output stream 248E from device 108E.

In device 108F, portion 114K of device 108F is defined by a trilayer laminate assembly 270 comprising cation exchange membrane 148/water splitting layer 280/anion exchange membrane 146 and anion exchange membrane 166, wherein cation exchange membrane 148 has a facing relationship with anion exchange membrane 166. Output water from portion 110K in stream 248F2 comprises an acid having a fifth concentration of protons, wherein that fifth concentration of protons is greater than the first concentration of protons in output stream 248A from device 108A, and greater than the second concentration of protons in output stream 248B from device 108B, and greater than the third concentration of protons in output stream 248D from device 108D, and greater than the fourth concentration of protons in output stream 248E from device 108E.

In device 108F, portion 114L of device 108F is defined by cation exchange membrane 148 and cathode 206. Output water from portion 114L in stream 250b comprises a salt solution.

Referring once again to FIG. 1, high pH water exits the cathode chamber (110) in pipe 120 and is fed into an ion exchange container (130). In one embodiment, the ion exchange media in container 130 comprises ion exchange resin beads. In one embodiment, the beads comprise organic polymers containing weak acid cation exchange sites. In one embodiment, the polymer backbones containing the ion exchange functional groups comprise polystyrene, polyacrylic acid, polyacrylonitrile, polymethacrylate, polyolefin, or a combination thereof. In one embodiment, the resin beads comprise interconnected pores, which provide increased surface area for the ion exchange reactions.

In one embodiment, the ion exchange media in ion exchange container 130 comprises ion exchange fibers. In some embodiments, the nominal dimension of the ion exchange fibers is approximately one tenth that of the ion exchange resin beads. As a result, the ion exchange fibers have, in comparison, faster mass transfer rates.

In one embodiment, the ion exchange media in ion exchange container 130 is weak acid ion exchange fibers. The weak acid ion exchange fibers consist of weakly acidic functional groups. As a result of exhibiting faster mass transfer rates over resin beads, weak acid ion exchange fibers can be effectively regenerated at a significantly higher pH than traditional weak acid ion exchange resin beads. In one embodiment, the weak acid ion exchange media has carboxylic acid functional groups. In one embodiment, the ion exchange container 130 contains Fiban® K-4, Mion® K-5 or similar ion exchange fibers. In one embodiment, for ion exchange fibers having 5 millimole equivalents of ion exchange sites per gram of material and assuming 400 gallons/day water consumption with a divalent cation concentration of 1.5 millimole per liter, 906 grams of fiber are necessary for 1 container regeneration per day. In one embodiment, the container size is 4 L, based on fibers packed with a density of 0.23 grams/cm³, which is much smaller than a typical 113 L container for a conventional ion exchange water softening system. In one embodiment, the ion exchange container 130 contains a shallow shell resin with an inert core. In one embodiment, the ion exchange container 130 contains Purolite SST-104.

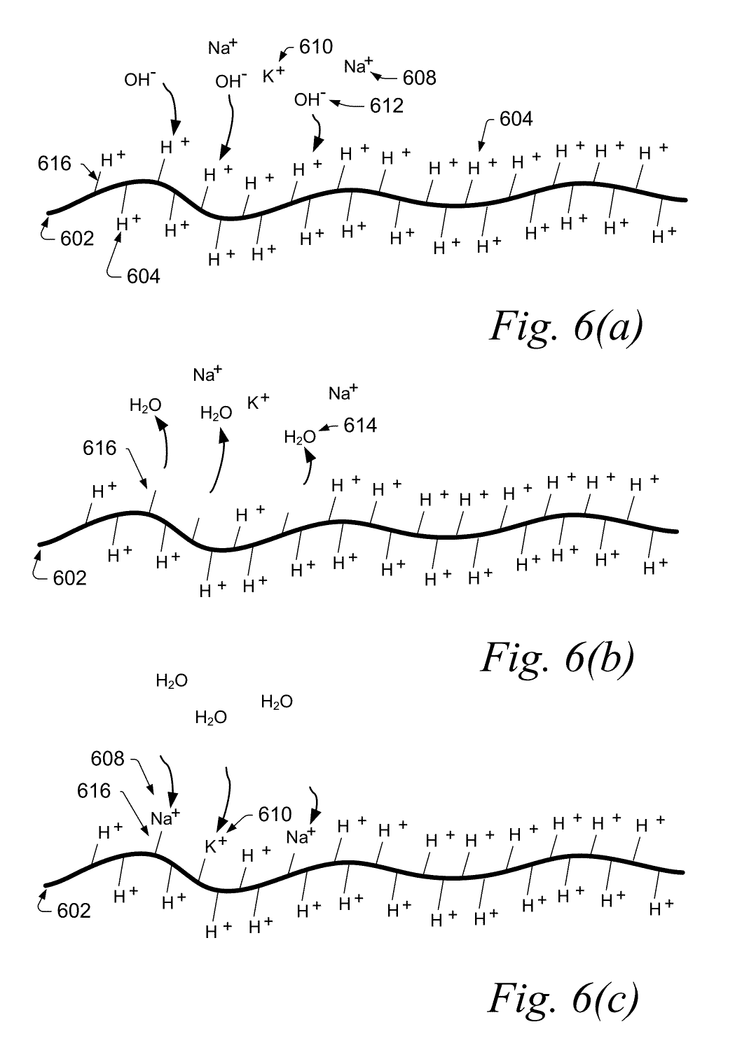

In one embodiment, the functional groups of the ion exchange media in ion exchange container 130 are initially loaded with hydrogen ions (H⁺). As the high pH stream passes over the ion exchange media, the hydroxide ions (OH⁻) neutralize the hydrogen ions, creating water (H₂O). Being neutral, the water molecules no longer bind to the ion exchange sites. The alkali cations in the stream bind to the vacated ion exchange sites. This process is as illustrated in FIGS. 6(a) to 6(c).

Referring to FIG. 6(a), an ion exchange fiber (602) having functional groups (616) initially loaded with hydrogen ions (604) is shown. As a flow of high pH water containing alkali cations, such as sodium (608) and potassium (610) pass over fiber 602, the hydroxide ions (612) neutralize the hydrogen ions (604). Referring to FIG. 6(b), the ion exchange fiber (602) of FIG. 6(a) after the combination of hydrogen ion (604) and hydroxide ion (612) to form water (614) and leaving a vacated functional group (616) is depicted. Referring to FIG. 6(c), the ion exchange fiber (602) of FIG. 6(b) after alkali cations 608 and 610 bind to the vacated functional groups (616) is depicted.

Over time, substantially all of the hydrogen ions (604) on the functional groups of the ion exchange media (602) will be replaced with alkali cations 608 and 610. Once saturation occurs, in one embodiment, the ion exchange media 602 is regenerated to displace the alkali cations 608 and 610 with hydrogen ions 604.

For purposes of clarity, FIGS. 6(a)-(c) are intended to depict only the general motion of the respective ions to illustrate interaction with the ion exchange fiber 602. FIGS. 6(a)-(c) are therefore not intended to be stoichiometrically accurate depictions of ion movement and interaction with functional groups 616.

Referring again to FIG. 1, because ion exchange container 130 serves to neutralize the high pH water and remove the alkali cations, the water exiting ion exchange container 130 in pipe 132 is substantially neutral and deionized. In one embodiment, the pH in pipe 132 is between about 4 and about 10. In one embodiment, the water from pipe 132 is fed into the anode chamber 114 of the electrochemical cell 108.

Low pH water exits anode chamber 114 in pipe 124 and is fed into ion exchange container 126. In one embodiment, an ion exchange media is disposed in ion exchange container 126. In one embodiment, the ion exchange media in container 126 comprises ion exchange resin beads. In one embodiment, the beads comprise organic polymers containing weak acid cation exchange sites. In various embodiments, the polymer backbones containing the ion exchange functional groups are derived from one or more of the following: polystyrene, polyacrylic acid, polyacrylonitrile, polymethacrylate or polyolefin. In one embodiment, the resin beads contain interconnected pores, which provide increased surface area for the ion exchange reactions.

In one embodiment, the ion exchange media in ion exchange container 126 comprises ion exchange fibers. In some embodiments, the nominal dimension of the ion exchange fibers is approximately one tenth that of the ion exchange resin beads. As a result, the ion exchange fibers have, in comparison, faster mass transfer rates.

In one embodiment, the ion exchange media in ion exchange container 126 is weak acid ion exchange fibers. The weak acid ion exchange fibers consist of weakly acidic functional groups. As a result of exhibiting faster mass transfer rates over resin beads, weak acid ion exchange fibers can be effectively regenerated at a significantly higher pH than traditional weak acid ion exchange resin beads. In one embodiment, the weak acid ion exchange media has carboxylic acid functional groups. In one embodiment, the ion exchange container 126 contains Fiban® K-4, Mion® K-5 or similar ion exchange fibers. In one embodiment, for ion exchange fibers having 5 millimole equivalents of ion exchange sites per gram of material and assuming 400 gallons/day water consumption with a divalent cation concentration of 1.5 millimole per liter, 906 grams of fiber are necessary for 1 container regeneration per day. In one embodiment, the container size is 4 L, based on fibers packed with a density of 0.23 grams/cm³, which is much smaller than a typical 113 L container for a conventional ion exchange water softening system. In one embodiment, the ion exchange container 126 contains a shallow shell resin with an inert core. In one embodiment, the ion exchange container 126 contains Purolite SST-104.

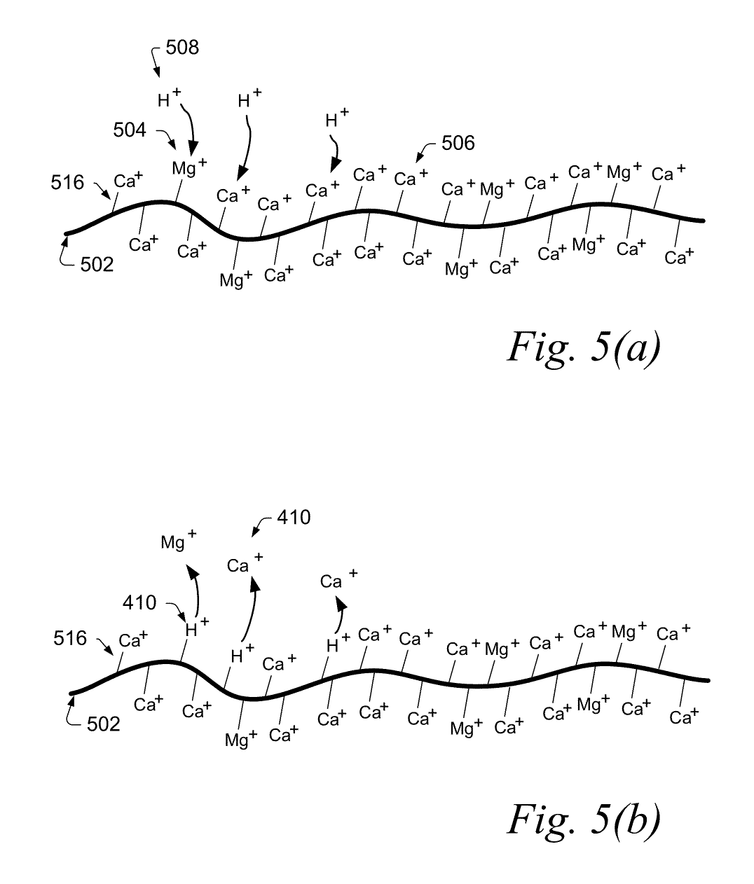

In one embodiment, the functional groups of the ion exchange media in ion exchange container 126 are initially loaded with divalent cations, such as Ca²⁺, Mg²⁺, Ba²⁺, Sr²⁺, Fe²⁺, and Cu²⁺. At pH values less than 3, the functional groups preferentially bind hydrogen ions (H⁺) over divalent cations. As such, the hydrogen ions in the acidic water passing over the ion exchange media bind to the ion exchange sites and the divalent cations are released into solution, as illustrated in FIGS. 5(a) and 5(b).

Referring to FIG. 5(a), an ion exchange fiber (502) having functional groups (516) initially loaded with the divalent cations calcium (506) and magnesium (504) is shown. As the flow of low pH water passes over fiber 502, the hydrogen ions (508) replace the divalent cations (504) and (506).

Referring to FIG. 5(b), ion exchange fiber 502 of FIG. 5(a) after the ion exchange of hydrogen ions (508) for divalent cations (504 and 506) is depicted. The hydrogen ions (508) are bound to the functional groups (516) and the divalent cations (504) and (506) are released into the water. Over time, substantially all of the divalent cations (504, 506) on the functional groups (516) of the ion exchange media (502) will be replaced with hydrogen ions (508). Once saturation occurs, in one embodiment, the ion exchange media (502) is regenerated to displace the hydrogen ions (508) with divalent cations (504 and 506).

The magnitude of the charge on each ion in FIG. 5 is not shown. For example, the Ca and Mg ions have a +2 charge and the H ions have a +1 charge. As such, a Ca or Mg ion will replace two H ions on the ion exchange fiber 502. Similarly, two H ions will replace a single Ca or Mg ion during regeneration. For purposes of clarity, FIGS. 5(a)-(b) are intended to depict only the general motion of the respective ions to illustrate interaction with the ion exchange fiber 502. FIGS. 5(a)-(b) are therefore not intended to be stoichiometrically accurate depictions of ion movement and interaction with functional groups 516.

Referring again to FIG. 1, the water exiting ion exchange container 126 in pipe 128 is hard due to the substantial amount of divalent cations. In addition, because a substantial portion of the hydrogen ions was removed in ion exchange container 126, the water in pipe 128 is substantially neutral. In one embodiment, the water in pipe 128 has a pH between 3 and 8. In one embodiment, the water exiting ion exchange container 126 in pipe 128 is discharged as wastewater. In one embodiment, the water exiting ion exchange container 126 in pipe 128 is discharged as a subsequent process feed.

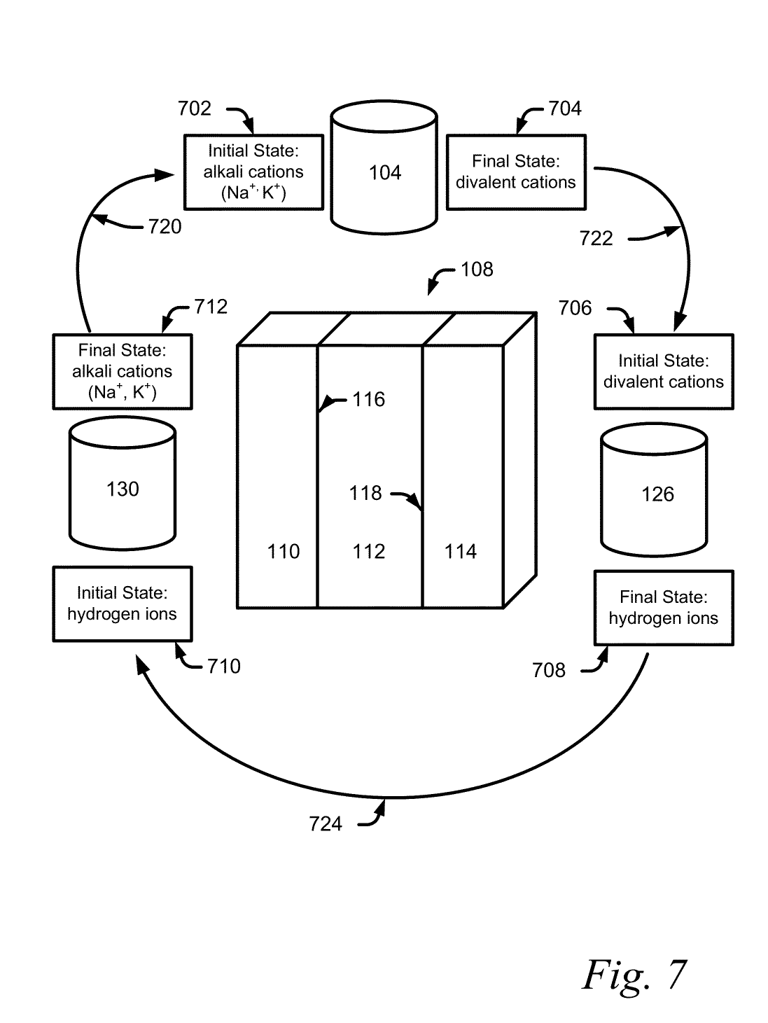

Ion exchange containers 104, 130, and 126 are cycled by rotating their relative positions in the water treatment system (100), as depicted in FIG. 7. In one embodiment, the piping remains stationary and physical position of the containers 104, 130, and 126 are rotated. In another embodiment, the containers 104, 130, and 126 remain stationary and the feed lines into each pipe are adjusted to effectively rotate the relative positions of the containers 104, 130, and 126 in the water treatment system 100.

In another embodiment, the water treatment system (100) is used to remove strong-binding anions from water. Ion exchange containers 104, 126, and 130 are packed with weak base anion exchange media. The ion exchange media in container 104 is loaded with chloride (Cl⁻), bicarbonate (HCO₃⁻) and other anions weakly bound by the weak base anion exchange media. As water fed into pipe 102 passes through ion exchange container 104, ions bound strongly by weak base ion exchange media, such as nitrate (NO₃⁻) and sulfate (SO₄²⁻), are removed from the water and replaced with the weakly bound anions. The strong-binding anions are substantially removed from the water in pipe 106, which passes into the electrochemical cell (108). The electrochemical cell (108) contains an anode chamber (110) and a cathode chamber (114). Water exiting the anode chamber 110 has a low pH and is fed into ion exchange container 130. Ion exchange media in container 130 is loaded with hydroxide ions (OH⁻). As the low pH water passes through ion exchange container 130, the weak-binding ions are removed from the water and replaced with hydroxide ions. The hydroxide ions combine with the hydrogen ions, producing water and neutralizing the pH of the stream. The neutral stream is then fed into the cathode chamber (114). Water exiting the cathode chamber (114) has a high pH and is fed into ion exchange container 126 by way of pipe 124. Ion exchange media in container 126 is loaded with strong-binding ions. As high pH water passes through ion exchange container 126, hydroxide ions are removed from the water (neutralizing the pH) and replaced with strong-binding ions. The neutralized water with a high concentration of strong-binding ions is discharged. The water exiting central chamber 112 in pipe 122 is neutral, partially deionized, and substantially free of strong-binding ions.

Referring to FIG. 2, the electrochemical reactions and ion movement in one embodiment of electrochemical cell 108 of FIG. 1 is depicted. In one embodiment, the electrochemical cell (108) comprises a cathode chamber (110), a central chamber (112), and an anode chamber (114). In one embodiment, the cathode chamber (110) and anode chamber (114) are each separated from the central chamber (112) by partitions 116 and 118.

In one embodiment, partitions 116 and 118 are membranes that allow anions and cations to pass freely from the central chamber into the anode chamber and cathode chamber, respectively, while restricting the flow of water. In different embodiments, the membrane comprises a polymer, such as polyolefin. In various embodiments, partitions 116 and 118 are plastic or ceramic plates with a ratio of surface to pore area of between about 30% to about 75%. The membranes serve primarily to help segregate the vertical flow between the three chambers 110, 112, 114. In this embodiment, the electrochemical cell (108) is configured to allow vertical flow of water without excessive mixing between chambers 110 and 112 and between chambers 112 and 114. In different embodiments, partitions 116 and 118 are comprised of ion exchange membranes, hydrophilic microporous polyethylene, hydrophilic expanded polytetrafluorethylene (ePTFE), polyethersulfone (PES), or polyolefin radiation grafted with acrylic acid.

In one embodiment, partitions 116 and 118 do not exist in the electrochemical cell (108). As such, the interior of electrochemical cell 108 comprises a single large chamber. In this embodiment, the electrochemical cell (108) is sufficiently large enough and configured such that the flow prevents excessive mixing between the flow in chamber 110 and the flow in chamber 112 and between the flow in chamber 112 and the flow in chamber 114.

The far side of the cathode chamber (110) includes a cathode (204). The far side of the anode chamber (114) includes an anode (206). In one embodiment, the electrochemical cell (108) is a parallel plate electrochemical cell with interelectrode gaps of 1-5 millimeters. In different embodiments, the anode and cathode are comprised of metal, metal alloy, graphite, conductive polymer, composite, semiconductor, or a combination thereof. In one embodiment, the anode and cathode are comprised of different materials. In one embodiment, the choice of anode material is based on minimizing the formation of oxidants. In one embodiment, the choice of anode material is based on minimizing the oxidation of chloride ions at the anode, which result in the production of hypochlorous acid (HClO) by the following reactions:

2Cl⁻_{(aq)}→Cl_{2(g)}+2e⁻

Cl_{2(g)}+H₂O [symbol] HCl_{(aq)}+HClO_{(aq)}

Hypochlorous acid is a strong oxidizer that may damage ion exchange media that contains organic materials. In one embodiment, the choice of anode is based on maximizing the production of oxidants. In certain embodiments, the generated oxidants are used as a biocide for anti-bacterial, anti-pathogenic, and sanitizing purposes. In various embodiments, as would be appreciated by those skilled in the art, oxidant-based biocides generated by Applicant's system are used in industrial applications, such as in cooling towers, oil rigs or refineries, to combat bacteria growth.

In one embodiment, the choice of anode material is based on maximizing the production of hypochlorous acid (HClO). In different embodiments, the anode comprises a titanium sheet coated with an oxygen evolving catalyst containing at least one of the species Pt, IrO₂, SnO₂, TaO₅, Sb₂O₅, or a combination thereof. In one embodiment, the anode comprises a graphite sheet with a catalyst, or a graphite sheet without a catalyst. In one embodiment, the anode comprises a graphite tube with a catalyst, or a graphite tube without a catalyst. In different embodiments, the cathode comprises an uncoated titanium sheet or tube, a stainless steel sheet or tube, or a graphite sheet or tube.

The cathode is electrically connected to the negative terminal (210) of a power source (208). The anode is electrically connected to the positive terminal (212) of a power source (208). In one embodiment, the power source (208) is configured to provide direct current at a constant voltage. In one embodiment, the voltage is about 10 V. In one embodiment, the voltage is about 20 V. In one embodiment, the voltage is less than 25 V. In one embodiment, the power source (208) is configured to provide direct current at a constant current. In one embodiment, the current is 5 A. In one embodiment, the current is 10 A. In one embodiment, the current is less than 15 A.

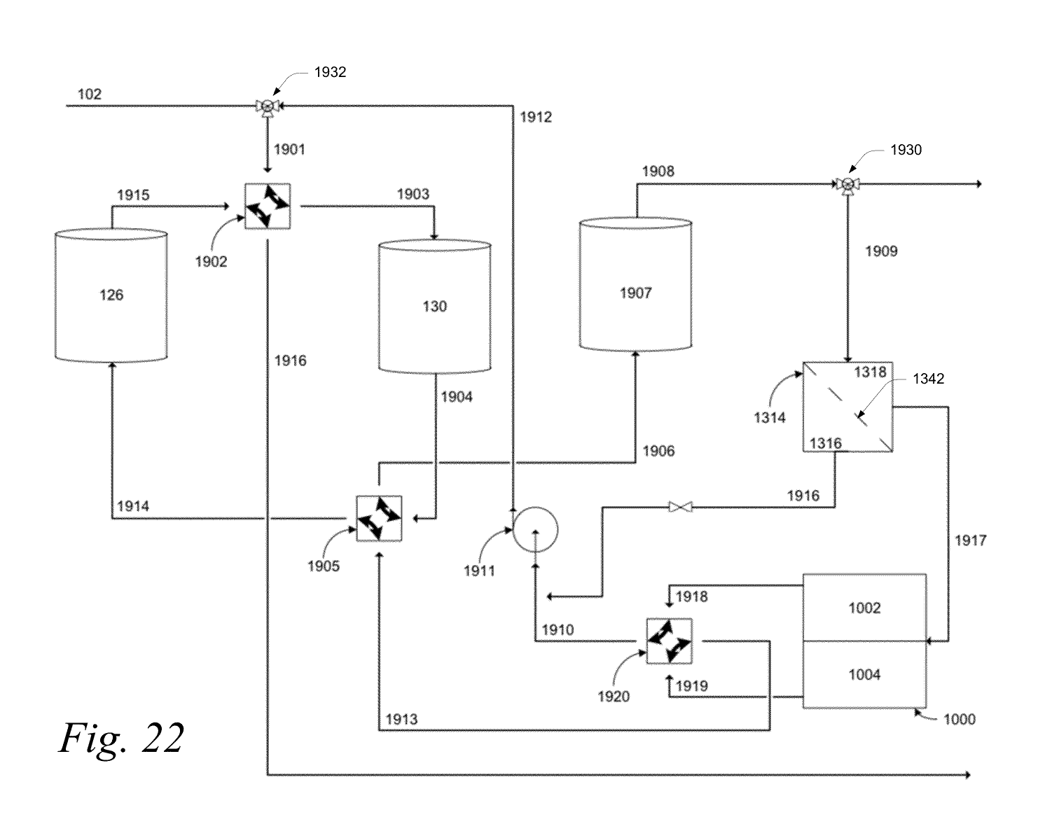

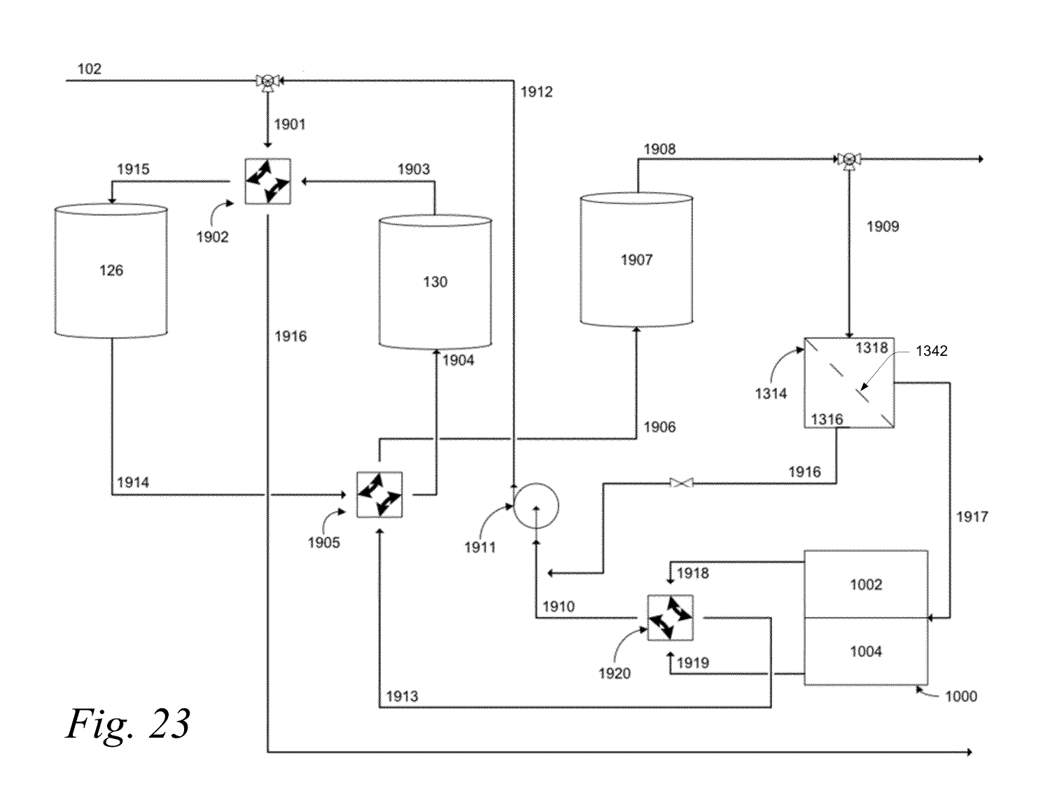

In one embodiment, the electrode potentials are periodically reversed. By periodically reversing the electrode polarity, fouling of the electrodes by mineral precipitates and organic materials can be reversed. FIGS. 22 and 23 depict exemplary embodiments of Applicant's water treatment system configured to use an electrochemical cell with alternating polarities. In different embodiments, the voltage or current is controlled to minimize the production of oxidants at the anode. In different embodiments, the voltage or current is controlled to minimize the production of hypochlorous acid (HClO) at the anode. In different embodiments, the voltage or current is controlled to maximize the production of oxidants at the anode. In different embodiments, the voltage or current is controlled to maximize the production of hypochlorous acid (HClO) at the anode. In one embodiment, the anode (206) and cathode (204) of the electrochemical cell (108) are spaced to maintain a voltage drop of between about 3 and about 15 V for incoming water containing an ion concentration of 50 millimoles per liter.

In one embodiment, the interior volume of chambers 110, 112, and 114 are packed with ion exchange media to decrease the ohmic loss across the electrochemical cell (108). The ion exchange media serves to increase the ionic concentration in each of the chambers and thereby increase the electrical conductivity of the solution. In one embodiment, the ion exchange media comprises ion exchange beads. In one embodiment, the ion exchange media comprises ion exchange fibers. In one embodiment, the ion exchange media comprises strong acid or strong base ion exchange fibers. As used herein, “strong acid cation exchange” media refers to ion exchange media with strong acid sites, such as sulfonic acid. As used herein, “strong base anion exchange” media refers to ion exchange media with strong base sites, such as quaternary amine functional groups.

The ion exchange media also serves to substantially slow the flow of cations and anions through the electrochemical cell (108) relative to the flow of water. This provides sufficient time for the majority of these ions to travel perpendicular to the flow of water and pass into the cathode chamber (110) or the anode chamber (114) before exiting the electrochemical cell (108). The positively charged cations balance the negatively charged hydroxide ions generated at the cathode. The negatively charged anions balance the positively charged hydrogen ions produced at the anode. In one embodiment, the faradic loss, which is the energy consumed in generating hydrogen at the cathode and oxygen at the anode, is less than the ohmic loss between the cathode and anode.

In some embodiments, the water to be treated will have a high concentration of ions. For example, sea water (for desalinization), membrane filter concentrate, and industrial waste water contains a high concentration of, for example, metal ions. In these embodiments, there are sufficient levels of ions present in the water that packing the electrochemical cell (108) with ion exchange media does not substantially reduce ohmic loss. As such, the electrochemical cell (108) is not packed with ion exchange material in these embodiments.

Referring to FIG. 2, a stream of soft water (202) (i.e., water in which the cation content is comprised primarily of alkali cations) is fed into the electrochemical cell (108). In one embodiment, soft water is fed into the central chamber (112) and the anode chamber (114). In one embodiment, soft water is fed into one or more of chambers 110, 112, and 114.

Referring to FIG. 2, water (222) is reduced at the negatively charged cathode (204). The cathode (204) transfers electrons (226) to water molecules (222), resulting in production of hydrogen gas (224) and hydroxide ions (218). The positively charged alkali cations (214) are attracted by the negative pole of the electric field generated at the cathode. The alkali cations (214) pass from central chamber 112, through partition 116, and into cathode chamber 110. The positively charged alkali cations (214) balance the negative charge of the hydroxide ions. The production of hydroxide ions increases the pH in the cathode chamber (110). In one embodiment, the stream of high pH water (244) exits the cathode chamber (110). In one embodiment, the pH of the water (244) exiting the cathode chamber (110) is between about 10 and about 14.

Referring to FIG. 2, water (228) is oxidized at the positively charged anode (206). The anode (206) accepts electrons (234) from water molecules (228), resulting in production of oxygen gas (230) and hydrogen ions (232). The negatively charged anions (216) are attracted by the positive pole of the electric field generated at the anode (206). The anions (216) pass from the central chamber (112), through partition 118, and into anode chamber 114. The negatively charged anions (216) balance the positive charge of the hydrogen ions. The production of hydrogen ions decreases the pH in the anode chamber (114). In one embodiment, a stream of low pH water (248) exits the bottom of anode chamber 114. In one embodiment, the pH of the water (248) exiting the anode chamber (114) is between about 0 and about 3.

In one embodiment, hydrogen gas migrates to the top of cathode chamber 110 and is released through gas relief valve 236. In one embodiment, the top of cathode chamber 110 is fitted with a gas permeable membrane made of expanded polytetrafluoroethylene. In one embodiment, the top of cathode chamber 110 is fitted with an expandable membrane to capture the gas. In one embodiment, the pipe receiving the water exiting cathode chamber 110 includes a gas permeable membrane that allows permeation and collection of the hydrogen while retaining the liquid phase. In one embodiment, the hydrogen gas is fed to a fuel cell for electricity generation.

In one embodiment, the oxygen gas migrates to the top of anode chamber 114 and is released through gas relief valve 238. In one embodiment, the oxygen gas migrates to the top of anode chamber 114, which is fitted with a gas diffusion membrane made of expanded polytetrafluoroethylene. In one embodiment, the pipe receiving the water exiting anode chamber 114 includes a diffusion membrane that allows permeation and collection of the oxygen while retaining the liquid phase. In one embodiment, the oxygen gas is fed to a fuel cell for electricity generation.

In one embodiment, the soft water stream (202) is fed into the bottom of the electrochemical cell (108) and the high pH stream (244), the low pH stream (248), and the stream of soft, demineralized water (246) exits the top of the electrochemical cell 108. The flow of water in this arrangement sweeps the hydrogen and oxygen gas produced as a result of the electrolysis reactions to the top of the electrochemical cell (108) for collection. In one embodiment, the stream of hydrogen and oxygen gas (240) and (242) may be used as fuel to offset the power consumption of the water treatment system (100).

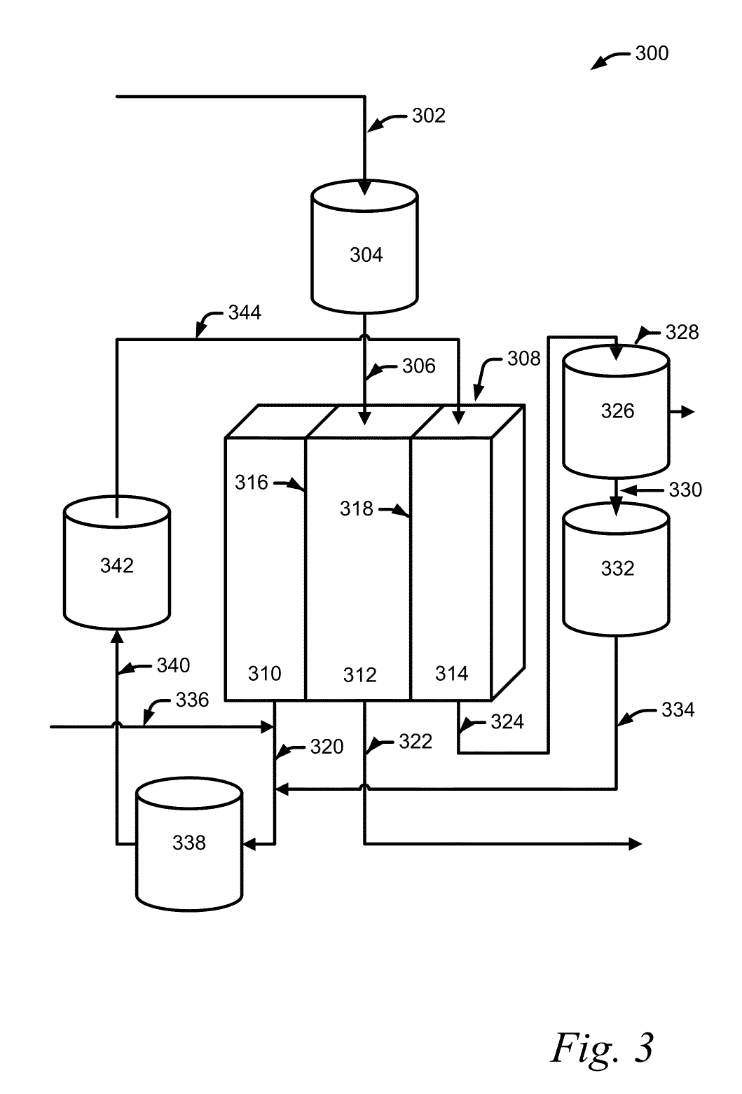

Referring to FIG. 3, an embodiment of Applicant's water treatment system (300) that produces no liquid waste is depicted. Hard water enters the water treatment system (300) through pipe 302. The hard water is fed into an ion exchange container (304). Ion exchange container 304 is initially loaded with alkali cations and is structurally and functionally identical to ion exchange container 104 of FIG. 1 and its embodiments, as described above. Soft water is produced when divalent cations present in the hard water flowing through ion exchange container 304 are exchanged with alkali cations, as illustrated in FIGS. 4(a) and 4(b). The resultant soft water flows out of ion exchange container 304 into electrochemical cell 308 through pipe 306.

Electrochemical cell 308 is structurally and functionally identical to electrochemical cell 108 of FIG. 1 and its embodiments, as described above. The electrochemical cell (308) has a cathode chamber (310), a central chamber (312), and an anode chamber (314). The soft water from pipe 306 enters the central chamber 312. The electrochemical cell 308 splits the incoming soft water, as described in relation to electrochemical cell 108 above, into a high pH stream (in pipe 320), a low pH stream (in pipe 324), and a neutral stream (in pipe 322). In one embodiment, the low pH stream in pipe 324 has a pH of at or below 2. In one embodiment, the high pH stream in pipe 320 has a pH at or above 10.

Water exiting pipe 322 is soft because it contains no appreciable amounts of dissolved minerals in the form of divalent or trivalent cations. The water in pipe 322 is also partially deionized because appreciable amounts of the alkali metal ions, which were added in ion exchange container 304, have been removed in the electrochemical cell (308). This water in pipe 322 is ready to be used for domestic or industrial purposes.

The low pH stream exiting the anode chamber (314) in pipe 324 is fed into an acid reservoir (326). In one embodiment, acid is periodically drawn from the acid reservoir (326). In one embodiment, a stream of acid (328) is used to periodically clean the electrochemical cell (308).

The low pH stream exiting the acid reservoir in pipe 330 enters ion exchange container 332. Ion exchange container 332 is initially loaded with divalent cations and is structurally and functionally identical to ion exchange container 126 of FIG. 1 and its embodiments, as described above. The hydrogen ions in the low pH stream are exchanged with divalent cations in ion exchange container 332, as illustrated in FIGS. 5(a) and 5(b). The stream exiting ion exchange container 332 in pipe 334 is substantially neutral. In one embodiment, the pH in the pipe 334 is between about 4 to about 9.

The high pH stream exits cathode chamber 310 in pipe 320. Carbon dioxide is dissolved in the water flowing through pipe 320. The high pH of the water in pipe 320 reacts with the dissolved carbon dioxide to create carbonate ions (CO₃⁻). In one embodiment, a portion of pipe 320 comprises microporous tubing that allows diffusion of atmospheric carbon dioxide into the water. In one embodiment, carbon dioxide gas is injected into pipe 320. The neutral water stream in pipe 334 feeds into pipe 320.

The stream in pipe 320 is fed into a crystallization chamber (338). In one embodiment, crystallization chamber 338 contains garnet, sand, calcium carbonate, magnesium carbonate, and barium carbonate crystals. These crystals grow as carbonate ions and divalent cations in the water combine to form solid phases that crystallize out of solution. As such, crystallization chamber 338 removes substantially all of the divalent cations from the water stream. As the crystals in crystallization chamber 338 grow, they must be periodically removed and replaced with smaller seed materials (e.g., CaCO_{3(S)}, CaSO_{4(S)}, garnet, silica sand, iron, aluminum, etc.).

The high pH and demineralized water exiting crystallization chamber 338 in pipe 340 is fed into ion exchange chamber 342. Ion exchange container 342 is initially loaded with hydrogen ions and is structurally and functionally identical to ion exchange container 130 of FIG. 1 and its embodiments, as described above. The hydroxide ions in the high pH stream are effectively exchanged with alkali cations in ion exchange container 342, as illustrated in FIGS. 6(a)-6(c). The stream exiting ion exchange container 342 in pipe 344 is substantially neutral. In one embodiment, the pH in pipe 344 is between about 5 to about 9. The substantially neutral water stream in pipe 344 is then circulated back through the anode chamber (314).

Referring to FIG. 7, a schematic depicts the regeneration of ion exchange containers 104, 126, 130 of the water treatment system (100) of FIG. 1. For clarity, only ion exchange containers 104, 126, 130, and the electrochemical cell (108) are shown, with other elements from FIG. 1 being omitted. Ion exchange media in ion exchange container 104 is initially saturated with alkali cations (702), primarily in the form of Na⁺ and K⁺. During operation of the water treatment system (100), the alkali cations are exchanged with divalent cations. In the final state, the ion exchange media is saturated with divalent cations (704). Ion exchange media in ion exchange container 126 is initially saturated with divalent cations (706). During operation of the water treatment system (100), the divalent cations are exchanged with hydrogen ions. In the final state, the ion exchange media is saturated with hydrogen ions (708). Ion exchange media in ion exchange container 130 is initially saturated with hydrogen ions (710). During operation of the water treatment system (100), the hydrogen ions are exchanged with alkali cations. In the final state, the ion exchange media is saturated with alkali cations (712).

Regeneration of ion exchange containers 104, 126 and 130 is accomplished by rotating the relative positions of the containers in the water treatment system (100). The ion exchange container in its final state saturated with alkali cations (712) is rotated (as indicated by arrow 720) to the position of ion exchange container 104, where it is in the proper initial state (702) for ion exchange container 104. Similarly, ion exchange container 104 in its final state saturated with divalent cations (704) is rotated (as indicated by arrow 722) to the position of ion exchange container 126, where it is in the proper initial state (706) for ion exchange container 126. Similarly, ion exchange container 126 in its final state saturated with hydrogen ions (708) is rotated (as indicated by arrow 724 to the position of ion exchange container 130), where it is in the proper initial state 710 for ion exchange container 130.

In one embodiment, the ion exchange containers are mounted in a single three-container assembly. The assembly is free to rotate, allowing any container to accompany any location 104, 126, or 130. The piping to each location is fixed. As such, the container assembly is rotated one position (as illustrated by arrows 720, 722, and 724) for each regeneration cycle. In one embodiment, the containers are rotated by an electric motor that is triggered by a controller. In one embodiment, the controller rotates the three-container assembly at a set interval, for example, once every 12 hours. In one embodiment, the controller directly or indirectly monitors the saturation of the ion exchange media in the containers through sensors, such as flow, voltage, current, pH or ionic detectors, and rotates the three-container assembly when the sensors indicate that the ion exchange media in one or more containers is sufficiently saturated. In one embodiment, the controller directly or indirectly monitors the potential drop or current across the electrochemical cell, and rotates the three-container assembly when the sensors indicate that the ion exchange media in one or more of the containers is sufficiently saturated.

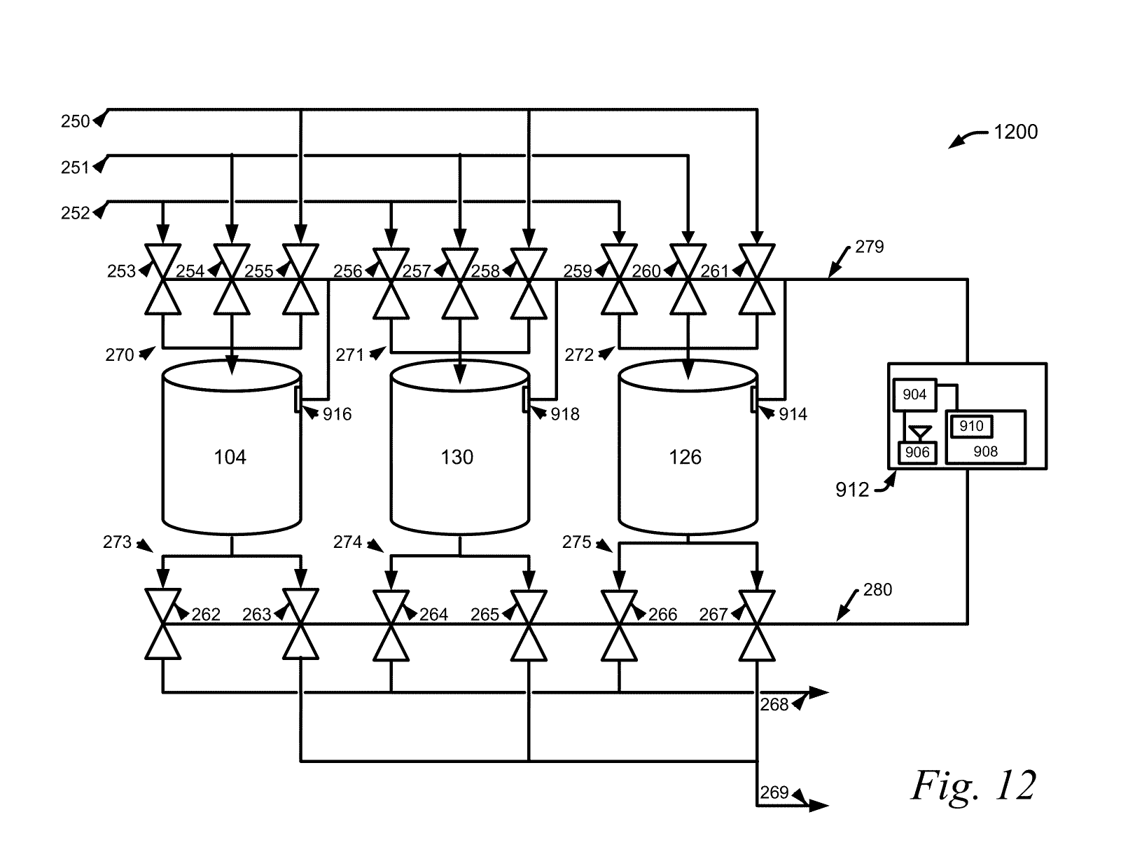

In one embodiment, the ion exchange containers are fixed and a series of valves and pipes are configured to operationally rotate their positions in the system, as depicted in FIG. 12. In one embodiment, the series of valves are triggered by a controller to operationally rotate the positions of the containers in the system. In one embodiment, the controller operationally rotates the containers at a set interval, for example, once every 12 hours. In one embodiment, the controller directly or indirectly monitors the saturation of the ion exchange media in the containers through sensors and operationally rotates the containers when the ion exchange media in one or more containers is sufficiently saturated.

In one embodiment, the ion exchange containers are fixed and a distribution box is used to operationally rotate their positions in the system. Referring to FIG. 1, pipes 102, 124, and 120 are fed into a distribution box, which can selectively feed the flow from pipes 102, 124, and 120 into containers 104, 126, and 130 respectively, containers 126, 130, and 104, respectively, or containers 130, 104, and 126, respectively. Water flows out of the distribution box through pipes 106, 128, and 132. The distribution box can selectively feed the flow from containers 104, 126, and 130 into pipes 106, 128, and 132, respectively, pipes 128, 132, and 106 respectively, or pipes 132, 106, and 128, respectively. In one embodiment, the distribution box is controlled by a controller to operationally rotate the positions of the containers in the system. In one embodiment, the controller operationally rotates the containers at a set interval, for example, once every 12 hours. In one embodiment, the controller directly or indirectly monitors the saturation of the ion exchange media in the containers through sensors and operationally rotates the containers when the ion exchange media in one or more containers is sufficiently saturated.

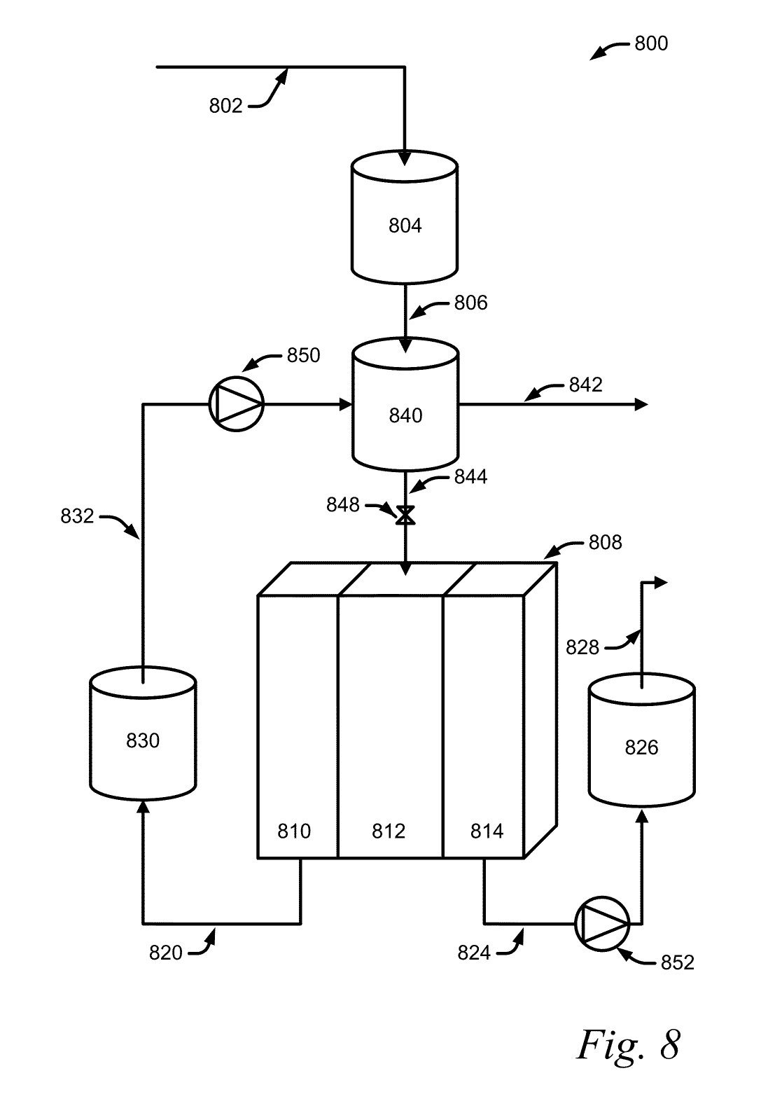

Referring to FIG. 8, an embodiment of Applicant's water treatment system (800) that electrolyzes soft water at a different pressure than the water supply is depicted. Hard water enters the water treatment system (800) in pipe 802. Hard waters passes through ion exchange container 804, where the hard water ions (i.e., divalent cations such as Ba²⁺, Ca²⁺, Mg²⁺, Fe²⁺, and Cu²⁺) are removed from the water and replaced with alkali cations, primarily in the form of Na⁺ and K⁺. Ion exchange container 804 is structurally and functionally identical to ion exchange container 104 of FIG. 1 and its embodiments as described above. The water exiting ion exchange container 804 in pipe 806 is soft (contains little appreciable amounts of hard water ions). The soft water in pipe 806 enters a water storage vessel (840). Water storage tank 840 holds the softened and partially deionized water, which is drawn from pipe 842 when needed for domestic or industrial use. In certain embodiments, water storage tank 840 is a typical household hot water tank or pipe network.

A portion of the water in water storage tank 840 is fed into an electrochemical cell (808) through pipe 844. The amount of water fed into electrochemical cell 808 is a function of the hardness of the water in pipe 802, which also determines the frequency of regeneration of ion exchange container 804. In one embodiment, the water fed into electrochemical cell 808 is between about 1 and about 10% of the amount of water fed into the water treatment system (800) in pipe 802. In one embodiment, pipe 844 is fitted with a pressure-reducing valve (848), which allows the electrochemical cell to operate at a much lower pressure than the supply water and the water in the storage tank.

The electrochemical cell (808) is structurally and functionally identical to electrochemical cell 108 of FIG. 1 and its embodiments, as described above. The electrochemical cell (808) has a cathode chamber (810), a central chamber (812), and an anode chamber (814). The soft water from pipe 844 enters central chamber 812. The electrochemical cell (808) splits the incoming soft water, as described in relation to electrochemical cell 108 above, into a high pH stream (in pipe 820) and a low pH stream (in pipe 824). In one embodiment, the low pH stream in pipe 824 has a pH of at or below about 2. In one embodiment, the high pH stream in pipe 820 has a pH at or above about 10.

The low pH stream in pipe 824 enters ion exchange container 826. In one embodiment, a pump (852) drives the stream into ion exchange container 826. Ion exchange container 826 is initially loaded with divalent cations and is structurally and functionally identical to ion exchange container 126 of FIG. 1 and its embodiments, as described above. The hydrogen ions in the low pH stream are exchanged for divalent cations in ion exchange container 826, as illustrated in FIGS. 5(a) and 5(b). The stream exiting ion exchange container 826 in pipe 828 is substantially neutral and is hard (i.e., contains a significant amount of divalent cations). In one embodiment, the pH in pipe 828 is between about 5 to about 9. The hard water stream in pipe 828 is discharged from the water treatment system (800).

The high pH stream in pipe 820 is fed into ion exchange container 830. The ion exchange media in container 830 is initially loaded with hydrogen ions and is structurally and functionally identical to ion exchange container 130 of FIG. 1 and its embodiments, as described above. The hydroxide ions in the high pH stream neutralize the H⁺ ions on the ion exchange media to produce water. This allows the ion exchange media to grab alkali cations out of solution, as illustrated in FIGS. 6(a) and 6(b). The stream exiting ion exchange container 830 in pipe 832 is substantially neutral. In one embodiment, the pH in pipe 832 is between 4 and 9. The substantially neutral water stream containing alkali cations in pipe 832 is then circulated back to the water storage tank 840 by pump 850.

The concentration of ions in the electrochemical cell (808) directly impacts the volume of water needed to regenerate ion exchange container 826. Given that the regeneration water in pipe 828 will be discharged, it is desirable to minimize this volume. For example, where 400 gallons per day is used with 1.5 milimole of hardness ions per liter, the moles of acid required can be determined from:

$$\frac{400 gal}{d} \times \frac{3.78 L}{gal} \times \frac{1.5 \cdot {10}^{- 3} mol - hardness ions}{L} \times \frac{2 mol - {H}^{+}}{mol - hardness ions} = 4.5 \frac{mol}{d}$$

If the volume of discharge water is 1% of the water fed into pipe 802, (i.e., 4 gal/day), an acid concentration of 0.30 mol/L is required. This will require a minimum concentration of 0.30 eq/L (equivalents/L) of counter anions consisting primarily of HCO₃⁻, Cl⁻ and SO₄²⁻. This is a factor of ˜20 greater than the anion equivalents in typical tap water. Therefore, the concentration of ions in the incoming water will need to be concentrated by a factor of 20 in order to generate a sufficiently strong acid for regeneration. If the volume of the reject water is increased to 10%, the concentration of counter ions required can be reduced to 0.030 eq/L. This will require only a 2-fold increase in the anolyte anion concentration over that in the incoming tap water.

An example can be used to illustrate how the flow rate in pipe 820 can be varied to change the ionic concentration of the water used for generating the acid. For the case where 40 gallons (151 L) per day will be used to regenerate the ion exchange container (826) loaded with divalent cations, the flow rate in pipe 824 will need to be 105 mL/min. If the flow rate of stream 820 is set at 210 mL/min (two times the flow rate in pipe 824), 120 gallons of water from storage tank 840 will be cycled through the central chamber 812 of the electrochemical cell (108) during the time that 40 gallons of hard water are discharged out pipe 828. This serves to increase the concentration of anions in the electrochemical cell to a value that is up to three times greater than that in storage tank 840. The higher concentration of anions in the electrochemical cell will allow production of a more concentrated acid and thereby reduce the volume of water needing to be used for regenerating the media in container 826.

In another example, if the flow rate of stream 820 is set at 525 mL/min (5 times the flow in pipe 824), 240 gallons of water from storage tank 840 will be cycled through the central chamber (812) of the electrochemical cell (108) during the time that 40 gallons of hard water is discharged out pipe 828. This serves to increase the concentration of anions in the electrochemical cell to a value that is up to 5 times greater than that in storage tank 840. The higher concentration of anions in the electrochemical cell will allow the production of a more concentrated acid and thereby reduce the volume of water needing to be used for regenerating the media in container 826.

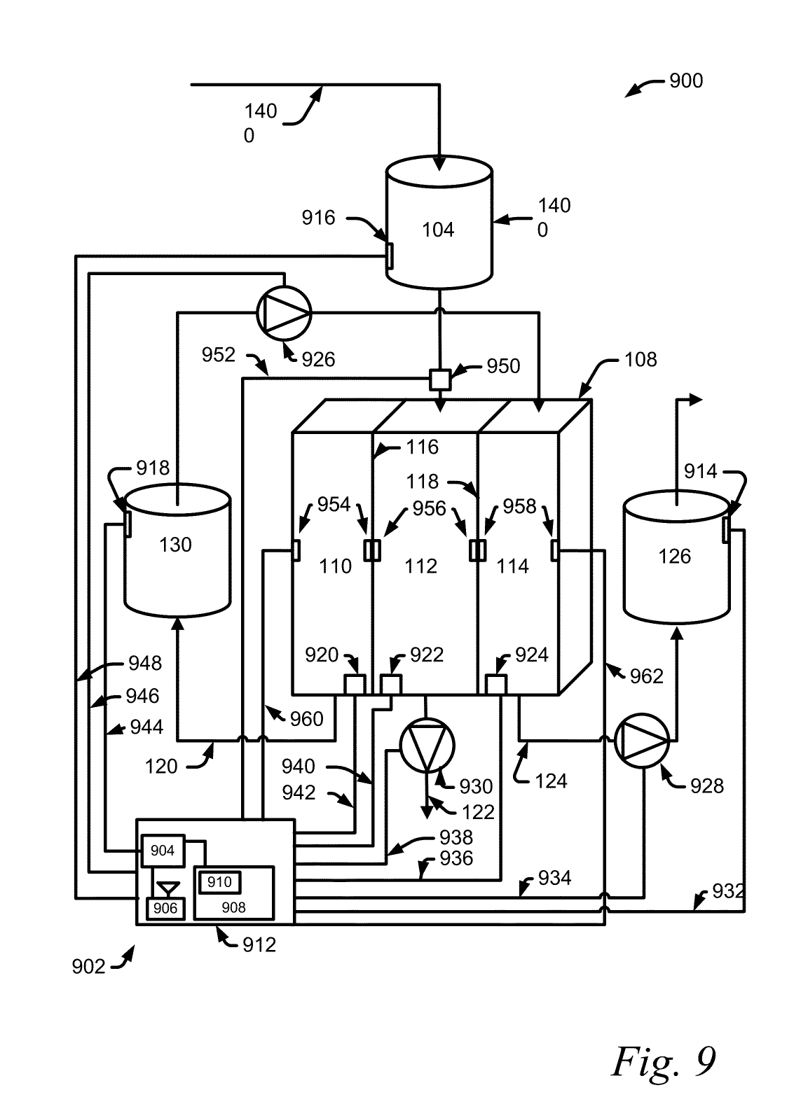

Referring to FIG. 9, an embodiment of Applicant's automatic water treatment system (900) operated by in integrated control system (902) is depicted. The automatic water treatment system (900) has the components of water treatment system 100 in FIG. 1 with the addition of an integrated control system (902). The integrated control system (902) includes a controller (912), sensors 914, 916, 918, 920, 922, 924, 950, 954, 956, 958, pumps and/or flow control valves 926, 928, and 930, and communication links 932, 934, 936, 938, 940, 942, 944, 946, 948, 952, 960, and 962. In one embodiment, at least one communication link 932, 934, 936, 938, 940, 942, 944, 946, 948, 952, 960, and 962 is a hard-wired connection. In one embodiment, at least one communication link 932, 934, 936, 938, 940, 942, 944, 946, 948, 952, 960, and 962 is a wireless connection.

In one embodiment, controller 912 comprises a processor (904), a computer readable medium (908), a computer readable program code (910) encoded in a computer readable medium (908), and a wireless communication interface (906). Processor 904, using computer readable program code 910, operates automatic water treatment system 900.

In different embodiments, sensors 914, 916, and 918 detect the pH, conductivity, and total flow rate of the water as it enters and exits ion exchange containers 126, 104, and 130, respectively. In different embodiments, sensors 914, 916, and 918 include a flow meter, pressure gauge, pH electrodes, ion-selective electrodes, conductivity probes, spectrophotometers, refractometers, lasers, laser diffraction analyzers, or a combination therein. In different embodiments, sensors 914, 916, and 918 measure the properties of the water entering or exiting its respective ion exchange container 126, 104, and 130, or both entering and exiting its respective ion exchange container 126, 104, and 130. Sensors 914, 916, and 918 transmit the detected values to controller 912 via communication links 932, 948, and 944, respectively.

In different embodiments, sensors 920, 922, and 924 detect the pH, conductivity, total fluid flow, pressure, concentration of specific families of ions, or a combination therein, in the cathode chamber (110), central chamber (112), and anode chamber (114), respectively. In one embodiment, sensors 920, 922, and 924 detect the flow rate through the cathode chamber (110), central chamber (112), and anode chamber (114), respectively. In one embodiment, sensor 950 detects the flow rate into the central chamber (112). The detected values from sensors 920, 922, 924, and 950 are transmitted to controller 912 via communication links 942, 940, 936, and 952, respectively.

In different embodiments, sensors 954, 956, and 958 measure the current through, voltage across, and/or pH within the chambers 110, 112, and 114.

In one embodiment, based on the data from the various sensors and program code 910, the controller maintains the proper flow through electrochemical cell 108 by controlling pumps (or valves) 926, 930, and 928 via communication links 946, 938, and 934, respectively. In one embodiment, the overall flow through electrochemical cell 108 must be maintained at a rate to flush hydroxide ions (generated at the cathode) and hydrogen ions (generated at the anode) out of the cell (via 120, 122, and 124) before they can travel across the chamber to the opposite electrode. Referring to FIG. 1, in one embodiment, the flow into the electrochemical cell (108) via multiple ports (here pipes 132 and 106) are controlled to create a pressure gradient across partition 116 that will result in a flow of water from central chamber 112, across partition 116, and into cathode chamber 110.

In one embodiment, upon detecting by way of pH and/or conductivity sensors that ion exchange container 104 is saturated with divalent cations, controller 912 triggers ion exchange containers 104, 126, and 130 to physically or effectively rotate positions as described in FIG. 7 above. In certain embodiments, the current through, voltage across, or pH within the cathode chamber (110) and/or across the anode chamber (114) is monitored by controller 912, periodically or in real-time, as a measure of the level of saturation in each chamber. In certain embodiments, the current or voltage value for the cathode 110 and anode 114 chambers are monitored at the power source as a measure of the level of saturation in each chamber. Upon a threshold voltage or current level, determined by the configuration of the particular system, controller 912 triggers the ion exchange containers 104, 126, and 130 to physically or effectively rotate. In other embodiments, the rotation of the ion exchange containers is triggered by controller 912 at set time intervals. In one embodiment, controller 912 controls the valves and/or motors to cause ion exchange containers 104, 126, and 130 to physically or effectively rotate positions as described in FIG. 7.

In certain embodiments, the controller 912 acquires and records data from the various sensors to create a historical dataset. In one embodiment, the dataset is fed into a learning algorithm to optimize the performance of the system over time.

In certain embodiments, the controller 912 tracks and adjusts the pH and/or flow rates throughout the system to synergize the kinetics across the ion exchange containers 104, 126, and 130.

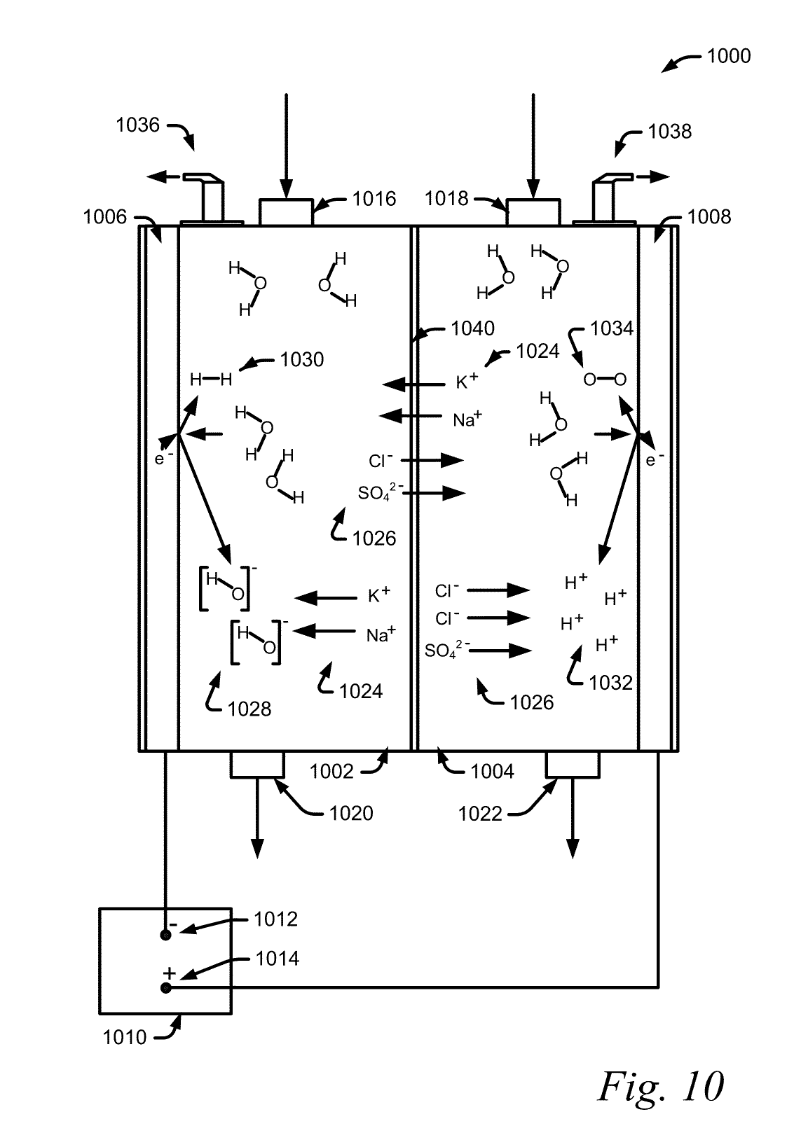

Referring to FIG. 10, another embodiment of an electrochemical cell (1000) to be used in Applicant's water treatment system is depicted. The electrochemical cell (1000) operates on the same principles as discussed in relation to FIG. 2 above. The electrochemical cell (1000) consists of a cathode chamber (1002) and an anode chamber (1004). The two chambers are separated by a partition (1040). The cathode chamber has an inlet (1016) and an outlet (1020). The anode chamber has an inlet (1018) and an outlet (1022).

The cathode chamber (1002) includes a cathode (1006). The anode chamber (1004) includes an anode (1008). The cathode is electrically connected to the negative terminal (1012) of a power source (1010). The anode is electrically connected to the positive terminal (1014) of a power source (1010). In one embodiment, the power source (1010) is configured to provide direct current at a constant voltage. In one embodiment, the voltage is about 5 to about 25 V. In one embodiment, the power source is configured to provide direct current at a constant current. In one embodiment, the current is 5 A. In different embodiments, the voltage or current is controlled to minimize the production of hypochlorous acid (HClO) at the anode. In different embodiments, the voltage or current is controlled to maximize the production of hypochlorous acid (HClO) at the anode.

Water flows through inlets 1016 and 1018. The alkali cations are attracted to the cathode (1006). A portion of the alkali cations (1024) in the anode chamber (1004) are pulled across the partition (1040) into the cathode chamber (1002). Likewise, the chloride and sulfate anions (1026) are attracted by the anode (1008). A portion of these anions (1026) in the cathode chamber (1002) are pulled across partition 1024 into anode chamber 1004. The cathode (1006) generates hydroxide ions (1028) and hydrogen gas (1030), as described in relation to FIG. 2 above. The anode (1008) generates hydrogen ions (1032) and oxygen gas (1034), as described in relation to FIG. 2 above. In one embodiment, the hydrogen gas is collected through valve (1036) and the oxygen gas is collected through valve (1038). A high pH stream leaves the cathode chamber (1002) through outlet port 1020. A low pH stream leaves the anode chamber (1004) through outlet port 1022.

Referring to FIGS. 11(a)-11(d), multiple flow configurations through the electrochemical cell for different embodiments of Applicant's water treatment system are depicted. The choice of an electrochemical cell flow configuration between FIGS. 11(a)-11(d), FIG. 2, or FIG. 10 depends on the particular purpose and configuration of the overall water treatment system.

In FIG. 11(a), a stream enters each of the cathode chamber (110), central chamber (112), and anode chamber (114). A high pH stream exits the cathode chamber (110), a low pH stream exits the anode chamber (114), and a neutral, partially deionized stream exits the central chamber (112).

In FIG. 11(b), a stream enters central chamber 112 only. A high pH stream exits cathode chamber 110, a low pH stream exits anode chamber 114, and a neutral, partially deionized stream exits central chamber 112.

In FIG. 11(c), a stream enters central chamber 112 only. A high pH stream exits cathode chamber 110 and a low pH stream exits anode chamber 114.

In FIG. 11(d), a stream enters each of the cathode chamber (110) and central chamber (112). A high pH stream exits the cathode chamber (110), a low pH stream exits the anode chamber (114), and a neutral, partially deionized stream exits the central chamber (112).

While the shape of the electrochemical cells depicted in FIGS. 2, 10, and 11(a)-11(d) is rectangular, Applicant's two- or three-chambered electrochemical cell may be configured, in other embodiments, to take on other shapes, including an annular configuration. In addition, while the electrochemical cell depicted herein comprises two electrodes, Applicant's two- and three-chambered electrochemical cells may be configured to, in other embodiments, to comprise three or more electrodes.

Referring to FIG. 12, a schematic showing one connection scheme (1200) for connecting ion exchange containers in the water treatment system (800) (shown in FIG. 8) in a manner that allows the containers to be regenerated by effectively rotating the containers in the system is depicted. The untreated, hard water is fed into pipe 250, low pH water (from the anode chamber 114) is fed into pipe 251, and high pH water (from the cathode chamber 110) is fed into pipe 252. In one embodiment, a four-way valve (270, 271, and 272) is coupled to the inlet of each ion exchange container 104, 130, and 126, respectively. In one embodiment, a three-way valve (273, 274, 275) is coupled to the outlet of each ion exchange container 104, 130, and 126, respectively. Water containing a concentrated level of divalent cations flows out of pipe 268 and, in one embodiment, is discarded. Soft water to be, in one embodiment, treated by the electrochemical cell (108) flows out of pipe 269.

Each valve 253-261 and 262-267 is in electronic communication with controller 912 via, in one embodiment, communication links 279 and 280, respectively. Each ion exchange container 104, 130, and 126 includes a sensor 916, 918, and 914, respectively. Each sensor 916, 918, and 914 is in electronic communication with controller 912 via, in one embodiment, communication link 279.

In different embodiments, sensors 914, 916, and 918 detect the pH, conductivity, and total flow of the water as it enters and exits ion exchange containers 126, 104, and 130, respectively. In different embodiments, sensors 914, 916, and 918 include a flow meter, pressure gauge, pH electrodes, ion-selective electrodes, conductivity probes, spectrophotometers, refractometers, lasers, laser diffraction analyzers, or a combination therein. In different embodiments, sensors 914, 916, and 918 measure the properties of the water entering its respective ion exchange container, exiting its respective ion exchange container, or both entering and exiting its respective ion exchange container.

The controller (912) comprises a processor (904), a computer readable medium (908), a computer readable program code (910) encoded in a computer readable medium (908), and a wireless communication interface (906). Processor 904, using computer readable program code 910 and data from sensors 916, 918, and 914, operates the valves to control the flow of water through the system.

Each four-way valve 270, 271, and 272 is configured to permit flow from only one input to flow into each container. For example, four-way valve 270 permits water flowing from only one of inlets 253, 254, or 255 to flow into the ion exchange container 104. Similarly, each three-way valve 273, 274, and 275 are configured to permit flow from the container to only one output. For example, three-way valve 273 permits water flowing out of ion exchange container 104 to flow out of only one of the outlets 262 or 263. Once controller 912, using computer readable program code 910 and data from sensors 916, 918, and 914, determines that the water softening ion exchange container (i.e., one of 104, 130, or 126 that is receiving the hard water and generating soft water) requires regeneration, controller 912 manipulates three-way (273, 274, 275) and four-way (270, 271, 272) valves to effectively rotate the three ion exchange containers 104, 130, and 126 in the system.

Controller 912 sets valves 253-261 and 262-267 so the system takes on one of three different configurations. The configurations effectively rotate the relative positions of ion exchange containers 104, 126, and 130 in the water treatment system (800). In the first configuration, ports 255, 260, 256, 263, 265, and 266 are open. This arrangement of valves directs untreated water from pipe 250 into ion exchange container 104, directs low pH water into ion exchange container 126, and directs high pH water into ion exchange container 130. Water exiting ion exchange containers 104 and 130 is directed to pipe 269 and into electrochemical cell 108. Water exiting ion exchange container 126 is directed to pipe 268 and is, in one embodiment, discarded.

In the second configuration, ports 258, 254, 259, 265, 267, and 262 are open. This arrangement of valves directs untreated water from pipe 250 into ion exchange container 130, directs low pH water into ion exchange container 104, and directs high pH water into ion exchange container 126. Water exiting ion exchange containers 126 and 130 is directed to pipe 269 and into the electrochemical cell 108. Water exiting ion exchange container 104 is directed to pipe 268 and is, in one embodiment, discarded.

In the third configuration, ports 261, 257, 253, 263, 267, and 264 are open. This arrangement of valves directs untreated water from pipe 250 into ion exchange container 126, directs low pH water into ion exchange container 130, and directs high pH water into ion exchange container 104. Water exiting ion exchange containers 104 and 126 is directed to pipe 269 and into electrochemical cell 108. Water exiting ion exchange container 130 is directed to pipe 268 and is, in one embodiment, discarded.

The controller (912) rotates through the configurations in the order described above each time it determines that a regeneration is necessary. After the third configuration, the system is set back to the first configuration. This connection scheme (1200) allows continuous operation of the water treatment system (800) because the controller (912) can instantly redirect the flow of water to alter the function of an ion exchange container from a water-softening mode to a series of two regeneration modes and back to a water-softening mode. In comparison, conventional ion exchange systems must be taken off-line, often for hours, for each regeneration.

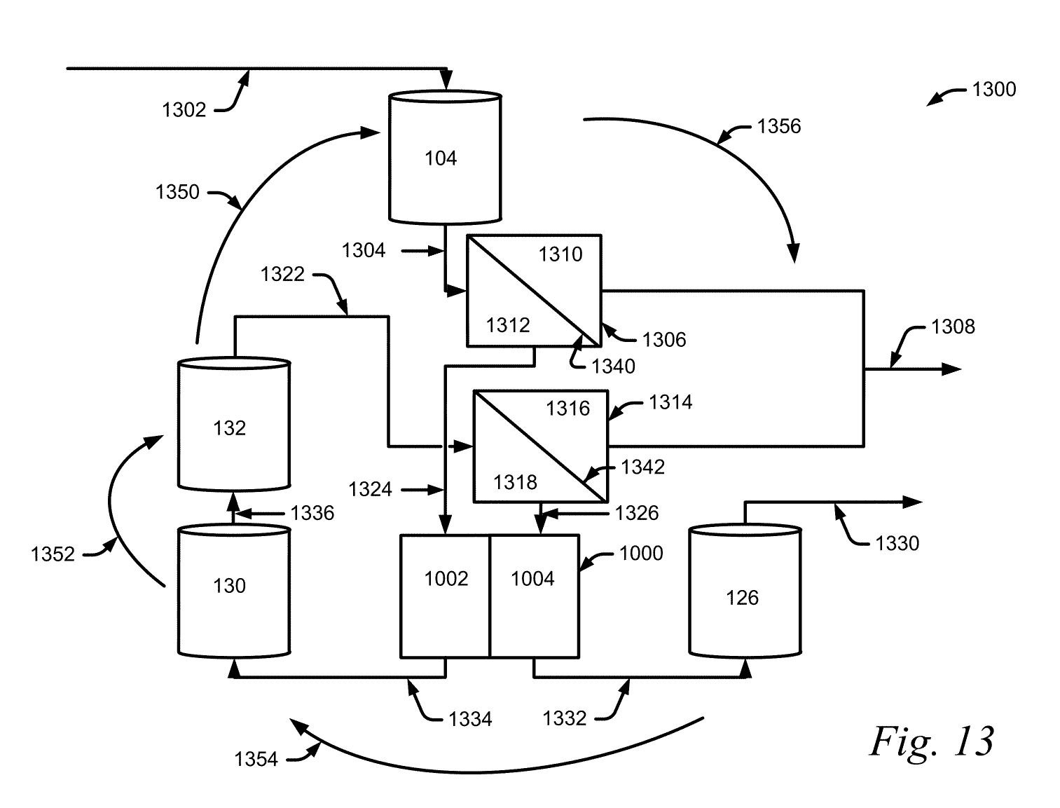

Referring to FIG. 13, one embodiment of Applicant's water treatment system (1300) using RO filters and the two chamber electrochemical cell of FIG. 10 is depicted. Untreated hard water (i.e., containing divalent cations) enters the water treatment system (1300) through pipe 1302 and enters ion exchange container 104. Ion exchange container 104 is initially loaded with alkali cations (i.e., Na⁺ and K⁺). As the water flows through ion exchange container 104, the divalent cations are extracted from solution and replaced with alkali cations, resulting in soft water entering pipe 1304. The soft water flows into RO filter 1306. The RO filter (1306) comprises two chambers (1312, 1320) and a membrane (1340). Water from chamber 1312 passes through membrane 1340 and into chamber 1310. The membrane (1340) is a selective membrane that allows water molecules to pass through, but traps many types of larger molecules and ions, such as alkali cations. As such, the alkali cations are retained in chamber 1312 and the water in chamber 1310 is free of alkali ions. This water is fed into pipe 1308 where it is used for domestic or industrial purposes.

The water containing concentrated levels of alkali cations is fed into the cathode chamber (1002) of the electrochemical cell (1000) of FIG. 12. By feeding this concentrated solution into chamber 1002 the ohmic power dissipation in cell 1000 is reduced. High pH water flows out of the cathode chamber (1002) and into ion exchange container 130 through pipe 1334. Ion exchange container 130 is initially loaded with hydrogen ions. The pH is neutralized and alkali cations are removed from the water as it passes through ion exchange container 130. The water then passes into ion exchange container 132 through pipe 1336. Ion exchange container (132) is also partially loaded with hydrogen ions. Ion exchange container 132 removes any remaining hydroxide ions and alkali cations that were not removed by ion exchange container 130.

Water from pipe 1322 is fed into RO filter 1314. RO filter 1314 removes any remaining alkali cations or other impurities from the output stream in pipe 1308 and feeds the water containing the impurities into anode chamber 1004 of electrochemical cell 1000. By feeding these impurities into anode chamber 1004, the ohmic power dissipation in cell 1000 is reduced. The low pH output stream is fed into pipe 1332 and into ion exchange container 126. Ion exchange container 126 is initially loaded with divalent cations. The hydrogen ions and some of the alkali metals are removed from solution and exchanged with divalent cations as the water passes through ion exchange container 126. The water, containing concentrated levels of divalent ions, is fed into pipe 1330 and, in one embodiment, discarded.

Ion exchange container 104 must be regenerated once it becomes saturated with divalent cations. The water treatment system (1300) is regenerated by replacing ion exchange container 104 with ion exchange container 132 (as shown by arrow 1350), replacing ion exchange container 132 with ion exchange container 130 (as shown by arrow 1352), replacing ion exchange container 130 with ion exchange container 126 (as shown by arrow 1354), and replacing ion exchange container 126 with ion exchange container 104 (as shown by arrow 1356).

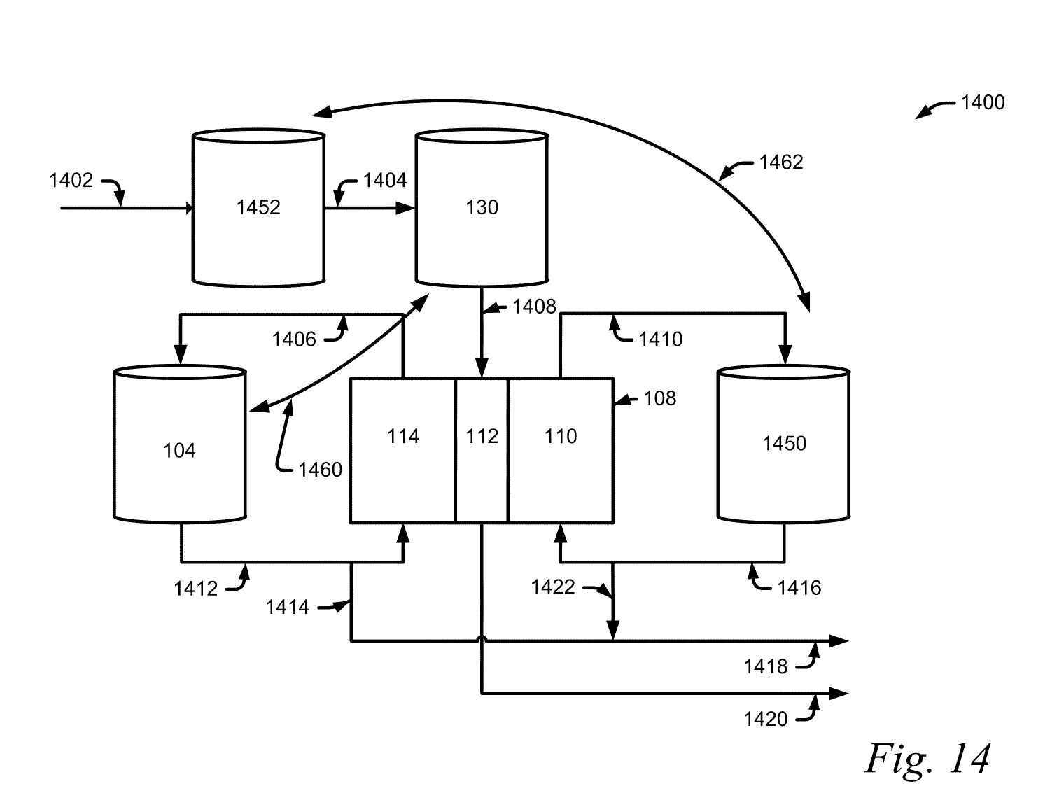

Referring to FIG. 14, one embodiment of Applicant's water treatment system (1400) using both weak acid cation exchange media and weak base anion exchange media is depicted. Untreated, hard water enters the water treatment system (1400) through pipe 1402 and enters ion exchange container 1452. Ion exchange container 1452 contains a weak base anion exchange media in the free base form. In one embodiment, the weak base anion exchange media may comprise secondary and/or ternary amine functional groups, such as dimethyl amine (e.g., Dowex Marathon® WBA-2). As water passes through ion exchange container 1452, the chloride ions (Cl⁻) and sulfate ions (SO₄²⁻) are removed by the weak base anion exchange media and replaced with hydroxide ions (OH⁻). The high pH stream exits ion exchange container 1452 and enters ion exchange container 130 through pipe 1404. Ion exchange container 130 is initially loaded with hydrogen ions (H⁺). As water passes through ion exchange container 130, the hard water ions (divalent cations) are removed by the weak acid cation exchange media and replaced with hydrogen ions, which react with the hydroxide ions to form water. The neutral and partially deionized stream is fed into the central chamber (112) of electrochemical cell 108 via pipe 1408.

Low pH water exits anode chamber 114 in pipe 1406 and enters ion exchange container 104. Ion exchange container 104 contains a weak acid cation exchange media that is initially loaded with divalent cations (e.g., Ca²⁺, Mg²⁺). As the low pH water passes through ion exchange container 104, the hydrogen ions are removed by the weak acid cation exchange media and are replaced by divalent cations. The neutralized stream is recirculated through the anode chamber via pipe 1412. This anode circulation loop (114->1406->104->1412->114) regenerates the ion exchange container 104 by saturating it with hydrogen ions. When ion exchange container 130 becomes saturated with divalent cations, ion exchange container 130 and 104 are swapped as shown by arrow 1460.

High pH water exits cathode chamber 110 in pipe 1410 and enters ion exchange container 1450. Ion exchange container 1450 contains a weak base anion exchange media that is initially loaded with chloride (Cl⁻) and sulfate (SO₄²⁻) anions. As the high pH water passes through ion exchange container 1450, the hydroxide ions are removed by the weak base anion exchange media and replaced chloride and sulfate ions. The neutralized stream is recirculated through the cathode chamber via 1412. This cathode circulation loop (110->1410->1450->1416->110) regenerates the ion exchange container 1450 by neutralizing the weak base anion exchange sites. When ion exchange container 1452 becomes saturated with chloride and sulfate ions, ion exchange container 1452 and 1450 are swapped as shown by arrow 1462.

A portion of the water in the anode circulation loop and the cathode circulation loop are drawn off into pipes 1414 and 1422 and into pipe 1418. The water in pipe 1418, which contains concentrated amounts of divalent cations, chloride anions, and sulfate anions, is, in some embodiments, discarded. The neutral and partially deionized stream from central chamber 112 is fed into pipe 1420 and is ready to use for domestic or industrial purposes.

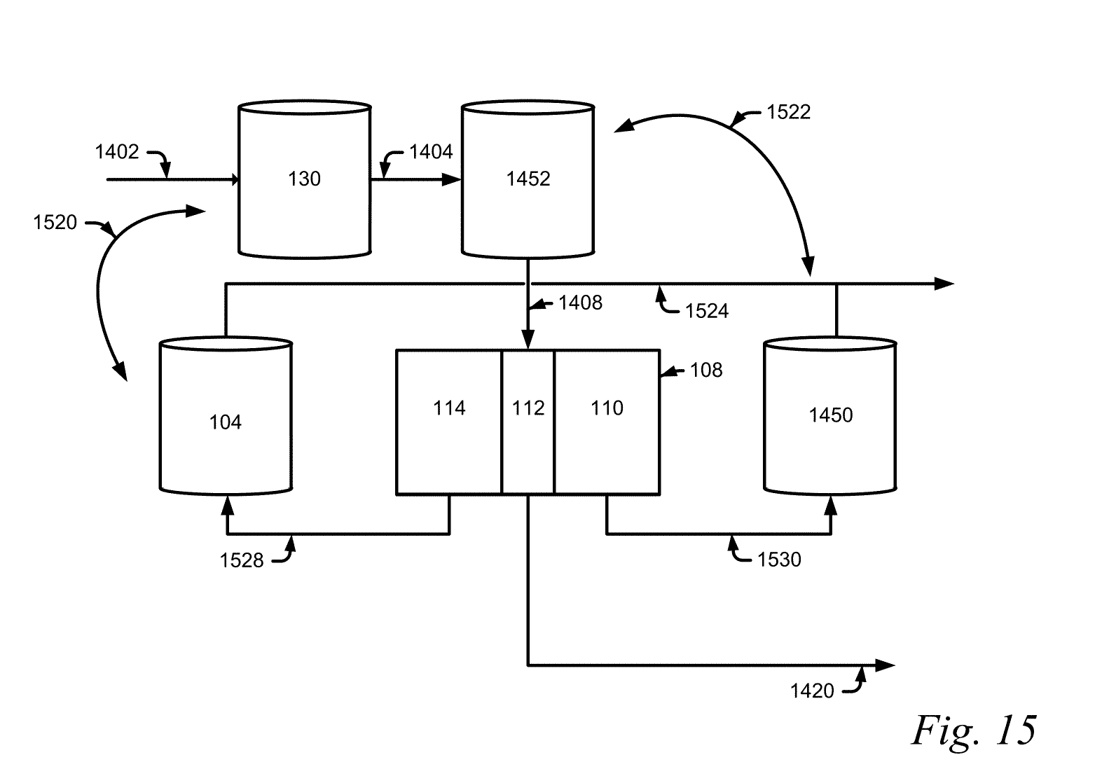

Referring to FIG. 15, a variation of the embodiment in FIG. 14 is depicted. The positions of ion exchange container 130 and ion exchange container 1452 are switched from FIG. 14. But, the effective state of the water in pipe 1408 is the same as that in FIG. 14. The low pH stream in pipe 1528 is fed through ion exchange container 104 where it is neutralized, loaded with divalent cations, and discarded in stream 1524. The high pH stream in pipe 1530 is fed through ion exchange container 1450, where it is neutralized, loaded with chloride and sulfate anions and discarded in stream 1524. When ion exchange container 130 becomes saturated with divalent cations, it is swapped with ion exchange container 104, as shown by arrow 1520. When ion exchange container 1452 becomes saturated with chloride and sulfate ions, it is swapped with ion exchange container 1450, as shown by arrow 1522.

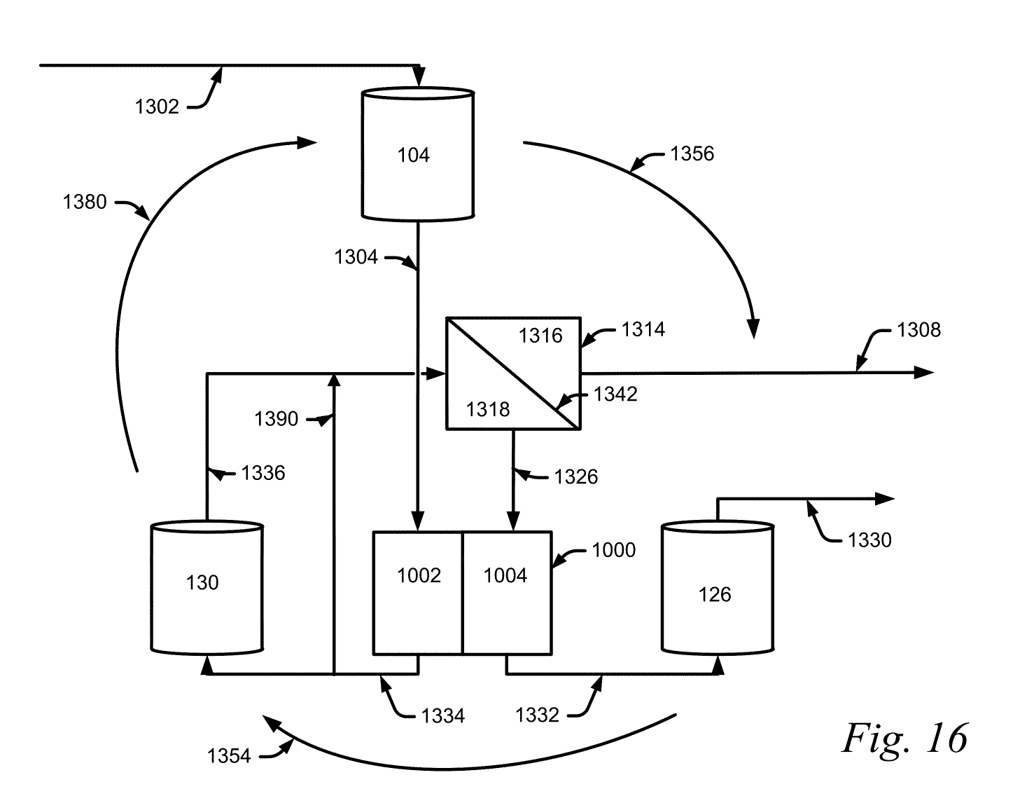

Referring to FIG. 16, a variation of the embodiment in FIG. 13 is depicted. A portion of the high pH stream from pipe 1334 is fed into pipe 1336 via pipe 1390. This combined stream is fed into RO filter 1314. The high pH in RO filter 1314 improves RO recovery because both the membrane as well as organic matter and dissolved species become negatively charged at high pH. As such, these materials are repelled from the membrane, preventing fouling of the membrane. When regeneration is necessary the ion exchange containers 104, 126, and 130 are rotated as depicted by arrows 1356, 1354, and 1380, respectively.

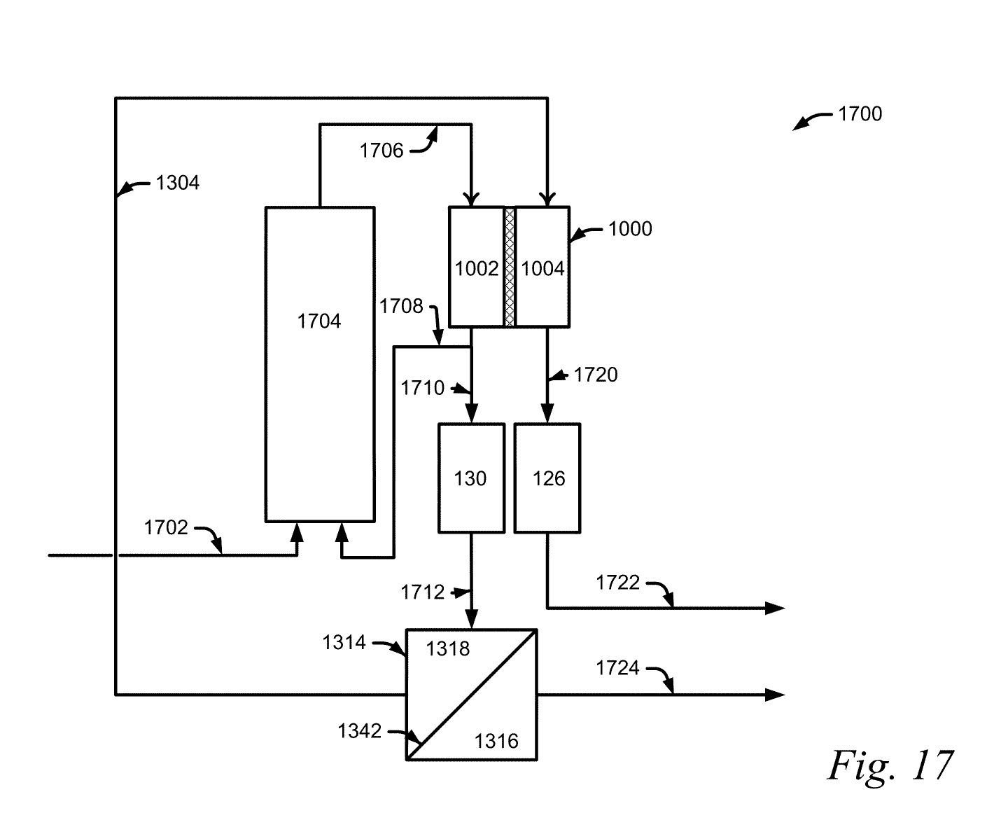

Referring to FIG. 17, one embodiment of Applicant's water treatment system (1700) using an electrochemical cell and a high pH RO filter is depicted. Hard water (i.e., containing divalent cations) is fed into the water treatment system (1700) via pipe 1702 and enters a crystallization chamber 1704. In different embodiments, the crystallization chamber initially contains seed particles of garnet, metal filings, plastic pellets, metal pellets, bio-balls, silica sand, mixed carbonate minerals, or a combination thereof, and is maintained at a high pH and/or carbonate alkalinity by the stream from pipe 1708. As hard water flows through the crystallization chamber (1704) the carbonate ions, the high pH, and the presence of seed particles promote the crystallization of hardness ions out of solution. As such, the crystals grow over time and must be periodically removed from the crystallization chamber 1704. This removal of hardness ion softens the water. This softened water exits crystallization chamber 1704 and is fed, via pipe 1706, into cathode chamber 1002 of two-chamber electrochemical cell 1000.

A high pH stream exits electrochemical cell 1000 and is fed into pipe 1710. A portion of the high pH stream is diverted from pipe 1710 and fed into crystallization chamber 1704 by way of pipe 1708. This stream maintains the pH and alkalinity in crystallization chamber 1704 that promotes the crystallization of hardness ions. In one embodiment, the stream in pipe 1710 has a pH of about 11. In one embodiment, the stream in pipe 1710 has a pH of 9 and is in equilibrium with the gas in pipe 1708. In one embodiment, the stream in pipe 1710 has a pH of greater than about 12. In one embodiment, the rate of water fed into crystallization chamber 1704 by way of pipe 1708 is configured to maintain a pH at or above about 10 in crystallization chamber 1704, after taking into account the neutral stream (1702).

The remainder of the high pH water in pipe 1710 is fed into ion exchange container 130. Ion exchange container 130 is initially loaded with monovalent cations. In different embodiments, ion exchange container 130 is loaded with hydrogen ions, alkali ions, or a combination therein. As the high pH water passes through the ion exchange container 130, any divalent cations in the stream that were not removed in crystallization chamber 1704 are removed by the ion exchange media and are replaced by monovalent cations. The water exiting ion exchange container 130 is fed into pipe 1712 and into RO filter 1314.

The RO filter 1314 concentrates the ions in the water, including any remaining hydroxide ions. As such, a high pH condition is created in RO filter 1314. In one embodiment, the pH in section 1318 of the RO filter 1314 is about 11. The high pH in RO filter 1314 improves RO recovery because the membrane as well as organic matter and dissolved species become negatively charged at high pH. As such, these materials are repelled from the membrane, preventing fouling of the membrane. The stream exiting RO filter 1314 via pipe 1724 is soft, demineralized, deionized and is ready for domestic or industrial use. The stream exiting RO filter 1314 via pipe 1304 contains a high concentration of ions and is fed into anode chamber 1004 of electrochemical cell 1000.

A low pH stream exits the electrochemical cell 1000 and is fed into ion exchange container 126 via pipe 1720. In one embodiment, electrochemical cell 1000 reduces the pH of the stream in pipe 1304 from about or greater than pH 10.0 to about or lower than pH 3.0 in pipe 1720. Ion exchange container 126 is initially loaded with divalent cations. As the low pH water passes through the ion exchange container 126, monovalent cations are removed by the ion exchange media and are replaced by divalent cations. The stream with a high concentration of divalent cations, is fed into pipe 1722 and is, in one embodiment, discarded.

Referring to FIG. 18, a flowchart 1800 summarizes one embodiment of using Applicant's water treatment system. Three weak acid ion exchange media containers are provided at step 1801 with container #1 is provided at position A, container #2 is provided at position B, and container #3 is provided at position C. Container #1 is initially loaded with alkali cations, such as Na⁺ and K⁺. Container #2 is initially loaded with hydrogen ions (H⁺). Container #3 is initially loaded with divalent cations, such as Ba²⁺, Ca²⁺, Mg²⁺, Fe²⁺, and Cu²⁺.

In one embodiment, the ion exchange media in one or more of the containers #1, #2, and #3 comprises weak acid ion exchange fibers. The weak acid ion exchange fibers consist of weakly acidic functional groups. In one embodiment, the ion exchange media in one or more of the containers #1, #2, and #3 has carboxylic acid functional groups. In one embodiment, the ion exchange media in one or more of the containers #1, #2, and #3 contains Fiban® K-4 ion exchange fibers. In one embodiment, the ion exchange media in one or more of the containers #1, #2, and #3 includes a shallow resin with an inert core.

A flow of hard water is directed through the ion exchange media in the container at position A in step 1802. As water flows over the ion exchange media, initially loaded with alkali cations, the divalent cations (hard water ions) in the water are removed and replaced with alkali cations. The removal of the divalent cations softens the water.

A flow of soft water is passed into an electrochemical cell at step 1804. The electrochemical cell, functionally similar to electrochemical cell 108 in FIG. 2, utilizes the anions and alkali cations contained in the water to produce a high pH stream and a low pH stream. In one embodiment, the high pH stream is about 12 and the low pH stream is about 2. In one embodiment, the high pH stream is about 12.3 and the low pH stream is about 1.7. In one embodiment, the high pH stream is about 13 and the low pH stream is about 1. In one embodiment, the high pH stream is about 11 and the low pH stream is about 3. In one embodiment, the high pH stream is greater than 10 and the low pH stream is lower than 4.

The high pH stream is directed through the weak acid ion exchange container at position B in step 1806. As water flows over the ion exchange media, initially loaded with hydrogen ions, the alkali cations in the water are removed and replaced with hydrogen ions (which is neutralized by the hydroxide ions to produce water). The removal of the alkali cations deionizes the water and the addition of hydrogen ions neutralizes the pH.

The low pH stream is directed through the weak acid ion exchange container at position C in step 1808. As water flows over the ion exchange media, initially loaded with divalent cations, the hydrogen ions in the water are removed and replaced with divalent cations. This removal of hydrogen ions neutralizes the pH and divalent cations removed earlier in the system are concentrated in this stream.

Over time, the ion exchange media in the container at position A will become depleted of alkali cations and become saturated with divalent cations. In step 1810, the method determines if the ion exchange media at position A is saturated with divalent cations. If the method determines in step 1810 that the ion exchange media at position A is not saturated with divalent cations, then the method transitions from step 1810 back to step 1802. If the method determines in step 1810 that the ion exchange media at position A is saturated with divalent cations, then the method transitions from step 1810 to step 1812.

In step 1812, the method determines the position of weak acid ion exchange container #1. If the method determines that weak acid ion exchange container #1 is at position A, then the method transitions from step 1812 to step 1814. Ion exchange container #1 is moved to position C, ion exchange container #3 is moved to position B, and ion exchange container #2 is moved to position A. This rotation of ion exchange containers regenerates the ion exchange container at position A. The method transitions from step 1818 back to step 1802.

If the method determines that weak acid ion exchange container #1 is at position B, then the method transitions from step 1812 to step 1820. Ion exchange container #1 is moved to position A, ion exchange container #3 is moved to position C, and ion exchange container #2 is moved to position B. This rotation of ion exchange containers regenerates the ion exchange container at position A. The method transitions from step 1824 back to step 1802.

If the method determines that weak acid ion exchange container #1 is at position C, then the method transitions from step 1812 to step 1826. Ion exchange container #1 is moved to position B, ion exchange container #3 is moved to position A, and ion exchange container #2 is moved to position C. This rotation of ion exchange containers regenerates the ion exchange container at position A. The method transitions from step 1830 back to step 1802.

A controller (912) has been described as including a processor controlled by instructions stored in a memory. The memory may be random access memory (RAM), read-only memory (ROM), flash memory or any other memory, or combination thereof, suitable for storing control software or other instructions and data. The functions performed by the controller (912) may be used to perform one or more steps of flowchart 1800. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

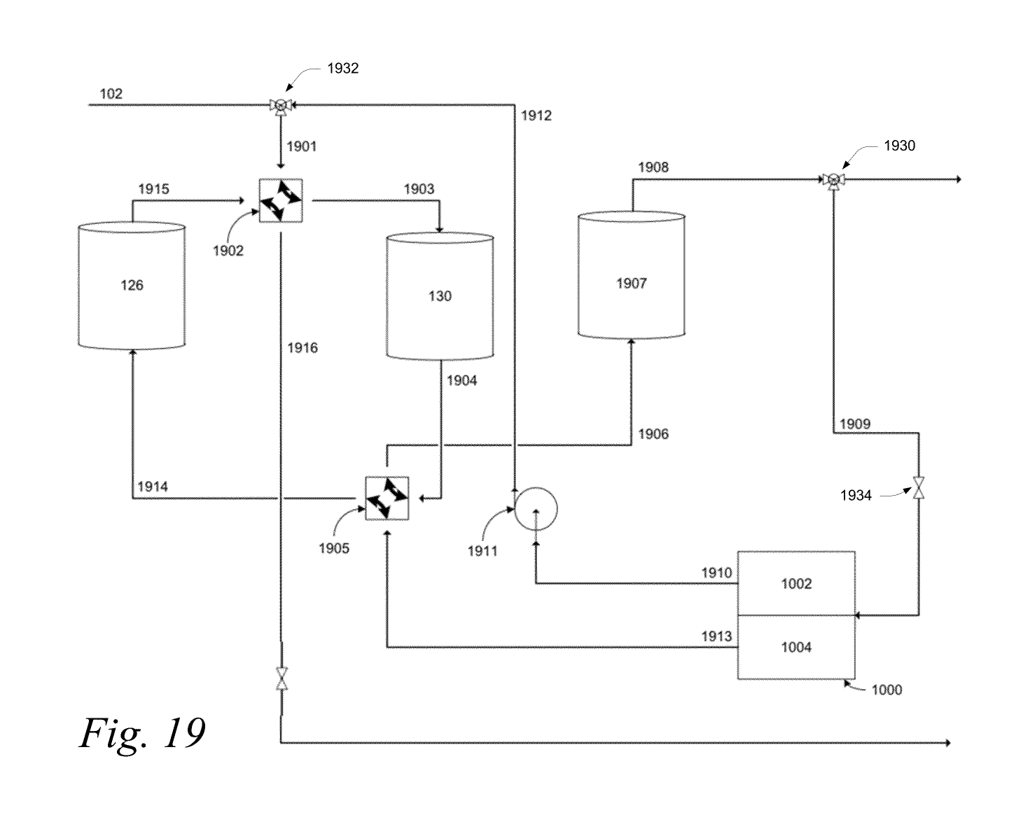

Referring to FIG. 19, one embodiment of Applicant's water treatment system using x-port valves in a first flow configuration is depicted. Hard water is fed to the system through pipe 102. The hard water is then mixed with the high pH solution in pipe 1912 at coupling 1932 forming the solution in pipe 1901. The solution in pipe 1901 is fed into container 130 by way of switching valve 1902 and pipe 1903. Container 130 contains weak acid cation exchange media in both the H⁺ and alkali cation form. Divalent cations in the hard water are exchanged for H⁺ and alkali cations on the weak acid cation exchange media. The softened water exits container 130 via pipe 1904 and flows to switching valve 1905. In one embodiment, switching valves 1905 and 1902 are x-port valves that take two input streams and direct them to a choice of two output streams. The water exits switching valve 1905 via pipe 1906 and enters container 1907, which contains weak base anion exchange media. The weak base anion exchange media is loaded with a variety of anions, such as OH⁻, Cl⁻, SO₄²⁻, and NO₃⁻. The OH⁻ ions in the weak base anion exchange media will neutralize any H⁺ ions that exit container 130. Neutral pH, softened water exits container 1907 via pipe 1908 and can be used for domestic or industrial purposes.

Electrochemical cell 1000 is used to continuously generate low and high pH streams. Softened water enters the electrochemical cell via pipe 1909. High pH water containing alkali cations and OH⁻ ions exits cathode chamber 1002 via pipe 1910. Pump 1911 is used to pump the high pH water into container 130 via pipes 1912, 1901, switching valve 1902 and pipe 1903. The alkali cations in the high pH water replace H⁺ ions on the media in container 130. The H⁺ ions that are released from the media combine with the OH⁺ ions to form water (H₂O). In different embodiments, pump 1911 may run continuously or intermittently. Once all the H′ ions on the media in container 130 are replaced by alkali cations, the OH⁺ ions that exit container 130 via pipe 1904 then flow into container 1907 via switching valve 1905 and pipe 1906. These OH⁺ ions serve to regenerate the weak base anion exchange media in container 1907 back to the free base form. The OH⁺ ions loaded onto the weak base anion exchange media can neutralize acid. The OH⁺ ions passed over the weak base anion exchange media can exchange for other anions, such as Cl⁻, and SO₄²⁻.

When OH⁻ ions exchange for other anions attached to the media, these anions will exit container 1907 via pipe 1908. They can then be drawn into pipe 1909 at coupling 1930 by way of the suction developed by pump 1911. The Cl⁻, SO₄²⁻ and other anions in pipe 1909 then enter electrochemical cell 1000 after, in one embodiment, flowing through regulator valve 1934. The anions then electromigrate into the anode chamber 1004 where they serve as the counter ions for acid production at the anode. Acid exits the anode chamber 1004 via pipe 1913.

The low pH solution in pipe 1913 is then diverted into pipe 1914 via switching valve 1905. Acid in pipe 1914 then enters container 126, which contains weak acid cation exchange media in the H⁺ and divalent cation forms. The H⁺ ions in the acid serve to regenerate the ion exchange media back to the H⁺ form. The hardness ions that are released from the ion exchange media then exit container 126 via pipe 1915. Pipe 1915 feeds the hardness ion containing water stream to switching valve 1902. The water containing the hardness ions then exits switching valve 1902 and is discharged via pipe 1916.

When the ion exchange media in container 130 becomes saturated with hardness ions, the media in container 130 is, in one embodiment, regenerated with acid. Regeneration of the media in container 130 is initiated by changing the configuration of switching valves 1902 and 1905.

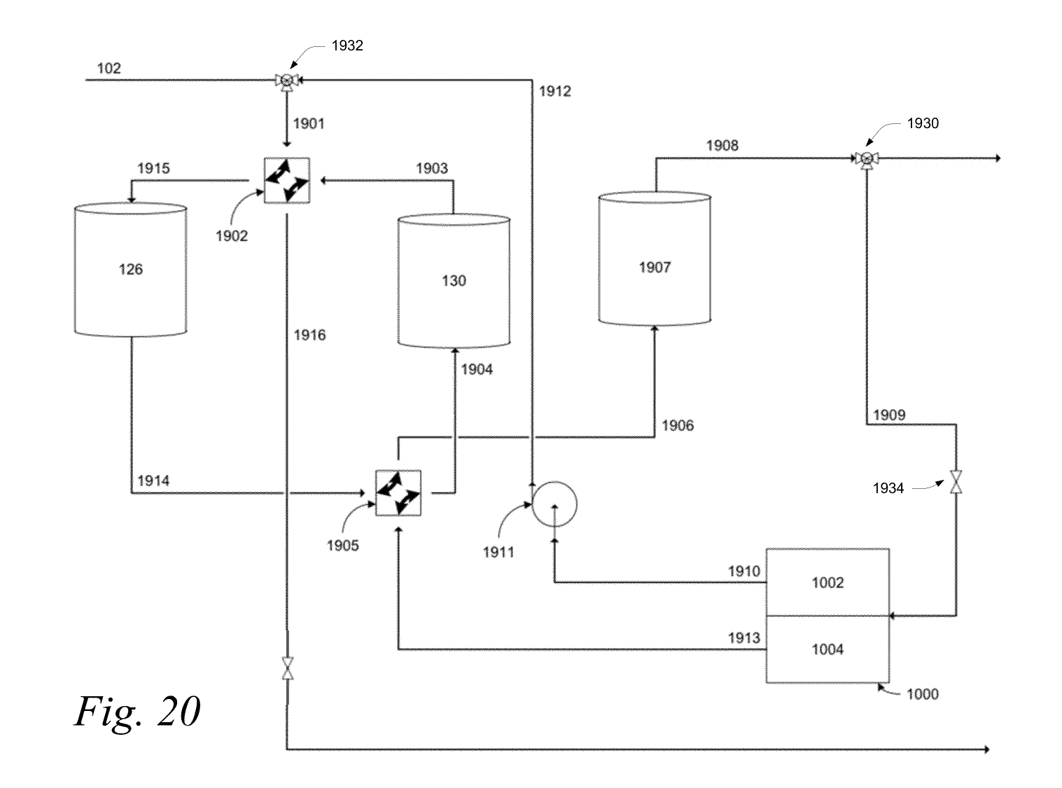

Referring to FIG. 20, a schematic of the embodiment of FIG. 19 with the x-port valves in a second flow configuration is depicted, resulting in the regeneration of container 130. In this configuration, water containing hardness ions in pipe 102 is diverted into container 126. The softened water exiting container 126 by way of pipe 1914 is then diverted to pipe 1906 by way of switching valve 1905. During regeneration of the ion exchange media in container 130, the acid in pipe 1913 is diverted into container 130 by way of switching valve 1905 and pipe 1904. The hardness ions released from the ion exchange media exit container 130 by way of pipe 1903. Valve 1902 then diverts the hardness ion containing water to pipe 1916. Once the ion exchange media in container 126 is saturated with hardness ions, the configuration of valves 1902 and 1905 are switched back to their configurations illustrated in FIG. 19 to regenerate container 126. Immediately after valves 1902 and 1905 revert back to their FIG. 19 configurations, the ion exchange media in container 130 is in the H⁺ form and can be used again to remove hardness ions from the feed water in pipe 102.

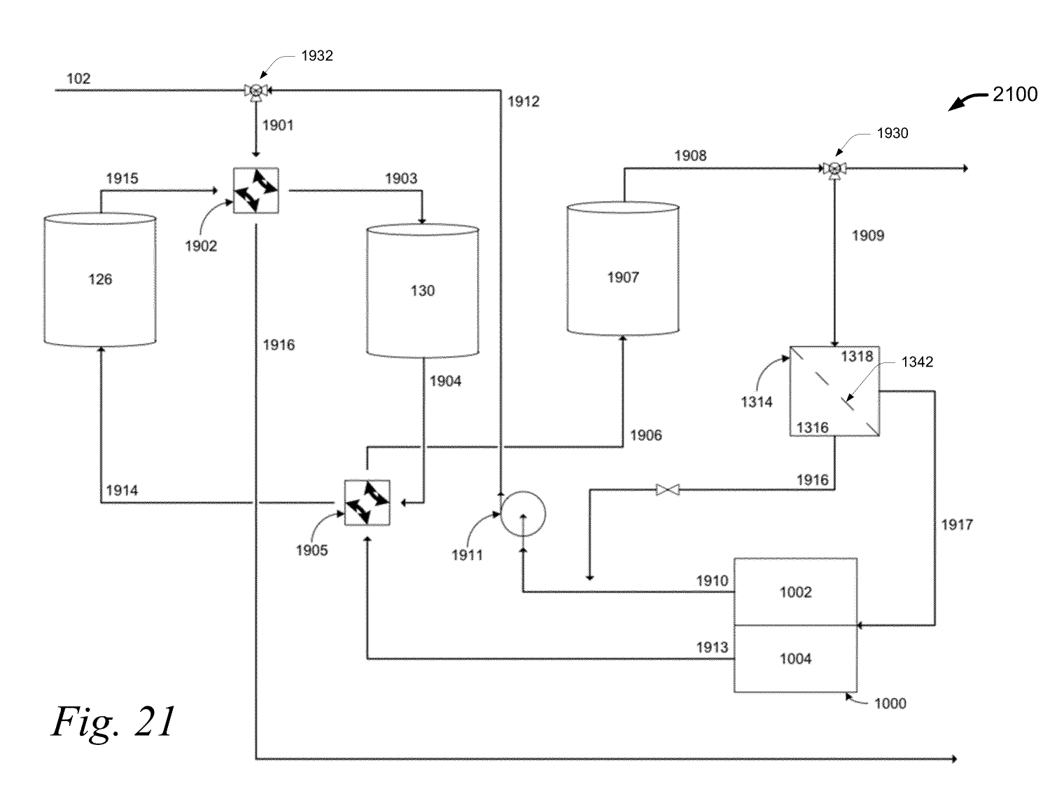

Referring to FIG. 21, a schematic of Applicant's water treatment system 2100 with a reverse osmosis unit to provide an ion boost is depicted. In addition to producing softened water, as in the system of FIG. 19/20, system 2100 also deionizes a portion of the water. A portion of the softened water in pipe 1908 is fed into reverse osmosis filter 1314 at coupling 1930 by way of pipe 1909. Water passing through the reverse osmosis membrane 1342 into chamber 1316 is deionized water. This water can be sent to a storage container or it can be feed back into container 130 by way of pipes 1916, pump 1911, pipe 1912 and 1901. Pumping the deionized water back to container 130 will lower the total mineral content in the softened water. The water that does not pass through the reverse osmosis filter, known as the concentrate, is retained in chamber 1318 of filter 1314. This water, which has a high concentration of dissolved ions, is then fed into the electrochemical cell by way of pipe 1917. The elevated concentration of dissolved ions in the concentrate reduce the omic power dissipation in the electrochemical cell and facilitates the production of more concentrated acids and bases. The higher the acid concentration, the smaller the volume of water that is needed to regenerate the ion exchange media in container 126.

Referring to FIG. 22, a schematic of one embodiment of Applicant's water treatment system using x-port valves in a first configuration and having an electrochemical cell configured to alternate polarity is depicted. The polarization of electrochemical cell 1000 is reversed after each regeneration cycle. This may be desired if there are elements in the water that may form scale on the electrode surfaces. This embodiment requires an additional stream switching valve 1920. In one configuration, switching valve 1920 diverts high pH water exiting the cathode chamber 1002 by way of pipe 1918 to pipe 1910. In this same configuration, valve 1920 diverts low pH water exiting the anode chamber 1004 by way of pipe 1919 to pipe 1913.

Referring to FIG. 23, a schematic of the embodiment of FIG. 22 with the x-port valves in a second flow configuration is depicted, resulting in the regeneration of container 130 and the reversal of polarity in the electrochemical cell 1000. The polarization on the electrodes in cell 1000 is reversed as is the position of switching valve 1920. Low pH water exiting the anode chamber 1004 by way of pipe 1919 is diverted to pipe 1910 by way of switching valve 1920. High pH water exiting the cathode chamber 1002 by way of pipe 1918 is diverted to pipe 1913 by way of switching valve 1920.

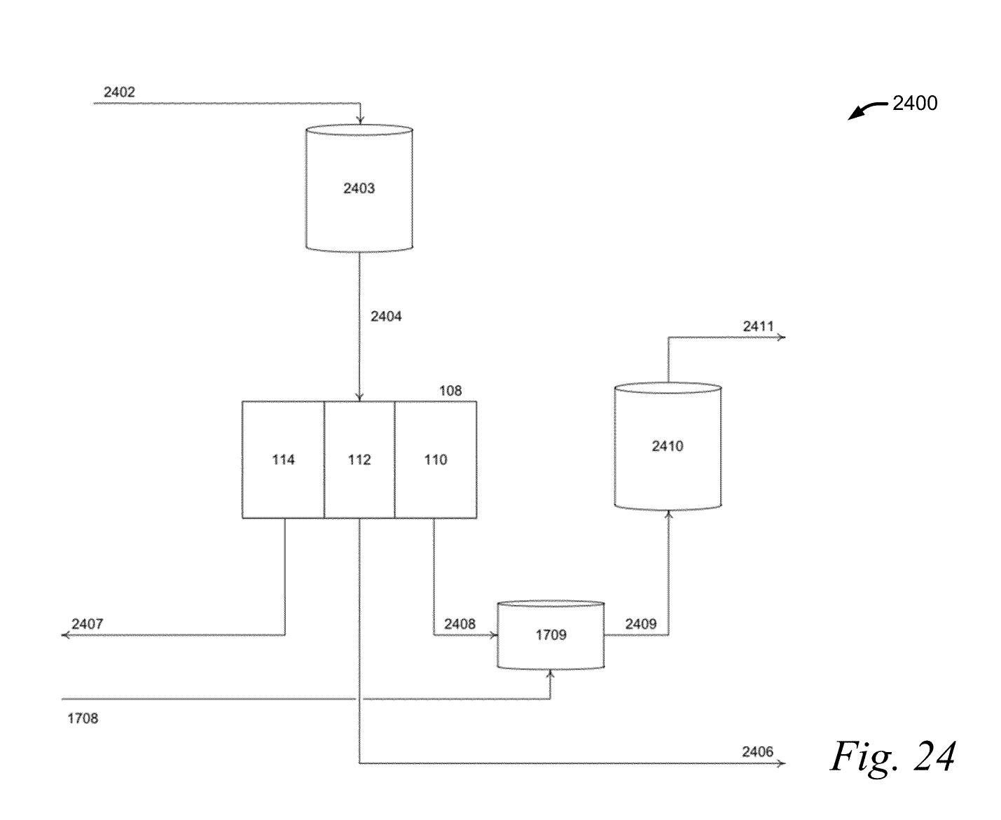

Referring to FIG. 24, one embodiment of Applicant's water treatment system 2400 having a three-chamber electrochemical cell and a liquid/gas contactor is depicted. The water treatment system 2400 employs strong base anion exchange media and a liquid gas contactor 1709 to remove target-anions (e.g., Cl⁻, NO₂⁻, SO₄²⁻, H₂AsO₄²⁻, etc.) from solution. In this embodiment, target-anion containing water is fed into water treatment system 2400 by way of pipe 2402. The raw solution in pipe 2402 is fed into strong base anion exchange container 2403.

In one embodiment, the media in container 2403 is initially in the bicarbonate form (HCO₃⁻). As the raw solution in pipe 2402 passes through container 2403, bicarbonate is exchanged for the target-anions. Target-anion free water exits container 2403 by way of pipe 2404, and is fed into middle chamber 112 of electrochemical cell 108. A low pH stream exits electrochemical cell 108 by way of pipe 2407, and, in one embodiment, is discharged from water treatment system 2400. A high pH stream exits electrochemical cell 108, by way of pipe 2408, and is fed into liquid/gas contactor 1709. In different embodiments, air, combustion flu gas, carbon dioxide gas, other gas mixtures containing carbon dioxide, or a combination thereof, is fed into liquid/gas contactor 1709 by way of pipe 1708. The solution in pipe 2408 and the gas in pipe 1708 are brought into intimate contact in liquid/gas contactor 1709 to facilitate stripping of carbon dioxide from the gas phase by the aqueous phase. The stream high in carbonate alkalinity exits liquid/gas contactor 1709 by way of pipe 2409 and is fed into strong base anion container 2410. The media in container 2410 is initially substantially loaded with target-anions. In one embodiment, as the solution in pipe 2409 passes through container 2410, bicarbonate is exchanged for target-anions on the strong base anion exchange media, thereby returning it back to the initial form of container 2403. Target-anion containing water exits container 2410 by way of pipe 2411 and, in one embodiment, is discarded. When the media in container 2403 is sufficiently loaded with target anions, containers 2403 and 2410 are exchanged. In one embodiment, the containers 2403 and 2410 are physically exchanged. In another embodiment, the containers 2403 and 2410 remain stationary and are functionally exchanged by rerouting the flow of material to and from said container.

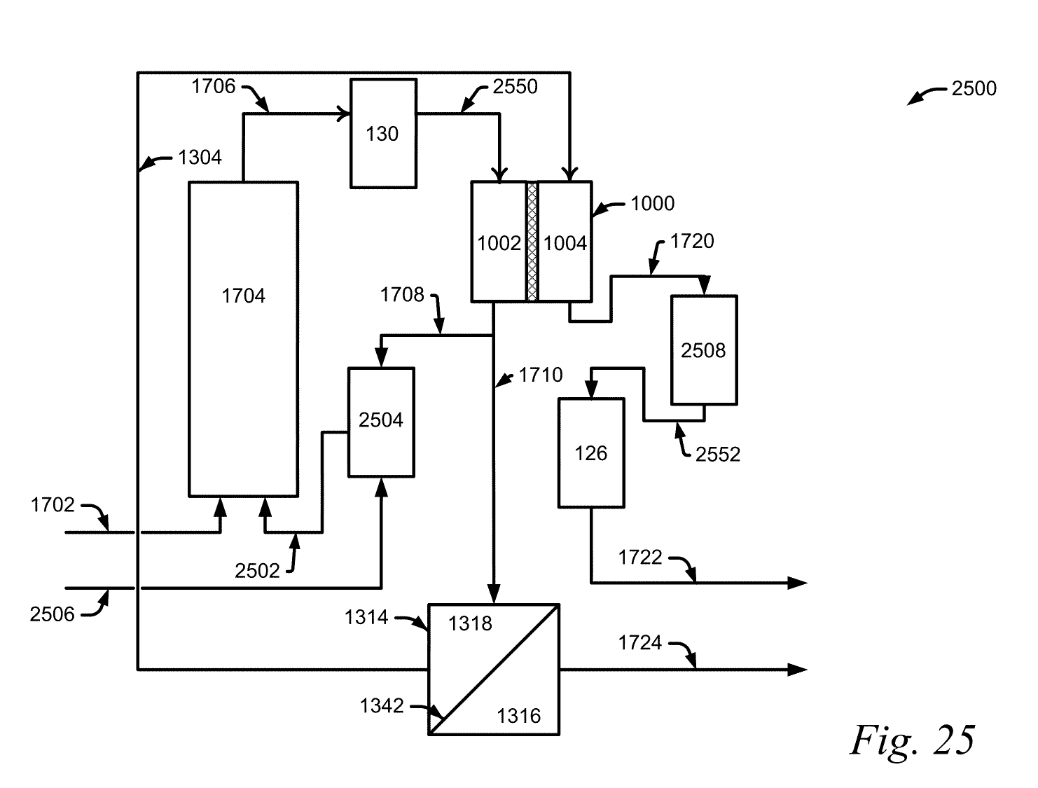

Referring to FIG. 25, one embodiment of Applicant's water treatment system (2500) using an electrochemical cell, a carbon filter, a high pH RO filter, and a liquid/gas contacter is depicted. Hard water (i.e., containing divalent cations) is fed into the water treatment system (2500) by way of pipe 1702 and enters a crystallization chamber 1704. In different embodiments, the crystallization chamber initially contains seed particles of garnet, metal filings, plastic pellets, metal pellets, bio-balls, silica sand, mixed carbonate minerals, or a combination thereof, and is maintained at a high pH and/or carbonate alkalinity by the stream from pipe 1902. As hard water flows through the crystallization chamber (1704) the carbonate ions, the high pH, and the presence of seed particles promote the crystallization of hardness ions out of solution. As such, the crystals grow over time and must be periodically removed from the crystallization chamber 1704. This removal of hardness ion softens the water. This softened water exits crystallization chamber 1704 and is fed, by way of pipe 1706, into ion exchange container 130.

Ion exchange container 130 is initially loaded with monovalent cations. In different embodiments, ion exchange container 130 is loaded with hydrogen ions, alkali ions, or a combination therein. As the high pH water passes through ion exchange container 130, any divalent cations in the stream that were not removed in crystallization chamber 1704 are removed by the ion exchange media and are replaced by monovalent cations. The soft water exits ion exchange container 130 and is fed, by way of pipe 2550, into cathode chamber 1002 of two chamber electrochemical cell 1000.

A high pH stream exits electrochemical cell 1000 and is fed into pipe 1710. A portion of the high pH stream is diverted from pipe 1710 and fed into liquid/gas contactor 2504 by way of pipe 1708. In different embodiments, air, combustion flue gas, carbon dioxide gas, other gas mixtures containing carbon dioxide, or a combination thereof is fed into liquid/gas contactor 2504 by way of pipe 2506. The solution in pipe 2506 and the gas in pipe 1708 are brought into intimate contact in liquid/gas contactor 2504 to facilitate stripping of carbon dioxide from the gas phase by the aqueous phase.

The high pH and/or high alkalinity stream exits liquid/gas contactor 2504 by way of pipe 2502. The high pH and/or high alkalinity stream in pipe 2502 is fed into crystallization chamber 1704. The material in pipe 2502 maintains the pH and alkalinity in crystallization chamber 1704 that promotes the crystallization of hardness ions. In one embodiment, the stream in pipe 2502 has a pH of about 11. In one embodiment, the stream in pipe 2502 has a pH of about 9 and is in equilibrium with the gas in pipe 2506. In one embodiment, the stream in pipe 2502 has a pH of greater than about 12. In one embodiment, the rate of water fed into crystallization chamber 1704 by way of pipe 2502 is configured to maintain a pH at or above about 10 in crystallization chamber 1704, after taking into account the neutral stream (1702).

The remainder of the high pH water in pipe 1710 is fed into RO filter 1314. RO filter 1314 concentrates all ions in the water, including any remaining hydroxide ions. As such, a high pH condition is created in RO filter 1314. In one embodiment, the pH in section 1318 of the RO filter is about 11. The high pH in RO filter 1314 improves RO recovery because the membrane 1342 as well as organic matter and dissolved species become negatively charged at high pH. As such, these materials are repelled from the membrane 1342, preventing fouling of the membrane 1342. The stream exiting RO filter 1314 by way of pipe 1724 is soft, demineralized, deionized and is ready for domestic or industrial use. The stream exiting RO filter 1314 by way of pipe 1304 contains a high concentration of ions and is fed into anode chamber 1004 of electrochemical cell 1000. In one embodiment, electrochemical cell 1000 reduces the pH of the stream in pipe 1304 from greater than a pH of about 10 to lower than a pH of about 3 in pipe 1720.

The low pH stream exits electrochemical cell 1000 by way of pipe 1720 and is fed into carbon filter 2508. The media in carbon filter 2508 functions to eliminate oxidants produced in anode chamber 1004 of electrochemical cell 1000. Oxidant free water exits carbon filter 2508 by way of pipe 2552 and is fed into ion exchange container 126.

Ion exchange container 126 is initially loaded with divalent cations. As the low pH water passes through ion exchange container 126, monovalent cations are removed by the ion exchange media and are replaced by divalent cations. This stream, with a high concentration of divalent cations, is fed into pipe 1722 and is, in one embodiment, discarded.

As would be appreciated by those skilled in the art, Applicant's system may be used to soften water by removing unwanted minerals as well as concentrating streams of dilute minerals. In a water purification/softening application, the desired output stream from Applicant's system comprises purified, softened water. The other output stream comprising concentrated hard water ions is generally discarded. In other applications, the concentrated mineral stream may be the desired output. For example, in certain embodiments, icant's system is used to concentrate a stream of dilute precious or other metals, such as without limitation gold, silver, platinum, palladium, copper, and/or nickel.

While the invention is described through the above-described exemplary embodiments, it will be understood by those of ordinary skill in the art that modifications to, and variations of, the illustrated embodiments may be made without departing from the inventive concepts disclosed herein. For example, although some aspects of Applicant's water treatment system have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. In addition, although a water treatment system has been described, the disclosed methods and structures may be used with other method, structures, and systems for other uses. Furthermore, disclosed aspects, or portions of these aspects, may be combined in ways not listed above. Accordingly, the invention should not be viewed as being limited to the disclosed embodiment(s).

What is claimed is:

1. An apparatus for treating water, comprising:
an electrochemical cell; and
at least one ion exchange container in fluid communication with said electrochemical cell.

2. The apparatus of claim 1, wherein said ion exchange container comprises a plurality of fibers each comprising a plurality of pendent functional groups, each pendent functional group comprising an alkali metal cation.

3. The apparatus of claim 2, wherein said plurality of fibers comprise a polymer backbone selected from the group consisting of polystyrene, polyacrylic acid, polyacrylonitrile, polymethacrylate, polyethylene, and polypropylene.

4. The apparatus of claim 1, wherein said electrochemical cell comprises:
a central chamber;
a cathode chamber comprising a cathode, wherein said cathode chamber is separated from said central chamber by a first water-permeable membrane; and
an anode chamber comprising an anode, wherein said anode chamber is separated from said central chamber by a second water-permeable membrane.

5. The apparatus of claim 4, wherein said first water-permeable membrane comprises a cation exchange membrane that permits passage of alkali metal cations but resists proton migration therethrough.

6. The apparatus of claim 1, wherein said electrochemical cell comprises a cathode chamber comprising:
a first cathode region separated from said central chamber by a first cation exchange membrane;
a second cathode region separated from said first cathode region by a second cation exchange membrane;
a third cathode region separated from said second cathode region by a third cation exchange membrane; and
a cathode disposed in said third cathode region.

7. The apparatus of claim 6, wherein said electrochemical cell comprises an anode chamber comprising:
a first anode region separated from said central chamber by a first anion exchange membrane;
a second anode region separated from said first anode region by a second anion exchange membrane;
a third anode region separated from said second anode region by a third anion exchange membrane;
a fourth anode region separated from said third cathode region by a fourth anion exchange membrane and
an anode disposed in said fourth anodic region.

8. The apparatus of claim 1, wherein said electrochemical cell comprises a central chamber comprising
a first central region defined by a first cation exchange membrane and a first anion exchange membrane;
a second central region defined by said first anion exchange membrane and a second cation exchange membrane;
a third central region defined by said second anion exchange membrane and a second cation exchange membrane;
a fourth central region defined by said first anion exchange membrane and a third cation exchange membrane; and
a fifth central region defined by said third cation exchange membrane and a third anion exchange membrane.

9. The apparatus of claim 1, wherein said electrochemical cell comprises a central chamber comprising
a first central region defined by a first cation exchange membrane and a first anion exchange membrane;
a second central region defined by said first anion exchange membrane and a second cation exchange membrane;
a third central region defined by said second anion exchange membrane and a second cation exchange membrane;
a fourth central region defined by said first anion exchange membrane and a third cation exchange membrane; and
a fifth central region defined by said third cation exchange membrane and a third anion exchange membrane.

10. The apparatus of claim 9, further comprising a cathode chamber comprising:
a first cathode region separated from said third central region by a said second cation exchange membrane;
a second cathode region separated from said first cathode region by a fourth cation exchange membrane;
a third cathode region separated from said second cathode region by a fifth cation exchange membrane;
a fourth cathode region separated from said third cathode region by a sixth cation exchange membrane; and
a cathode disposed in said fourth cathode region.

11. The apparatus of claim 10, wherein said electrochemical cell comprises an anode chamber comprising:
a first anode region separated from said central chamber by said third anion exchange membrane;
a second anode region separated from said first anode region by a fourth anion exchange membrane;
a third anode region separated from said second anode region by a fifth anion exchange membrane;
a fourth anode region separated from said third cathode region by a sixth anion exchange membrane; and
an anode disposed in said fourth anodic region.

12. The apparatus of claim 1, wherein said electrochemical cell comprises:
a first region defined by a first anion exchange membrane and a first cation exchange membrane;
a second region defined by said first anion exchange membrane and a first trilayer laminate assembly comprising a second cation exchange membrane, a second anion exchange membrane, and a middle layer comprising a first water splitting catalyst layer, wherein said first anion exchange layer and said second cation exchange layer have a facing relationship;
a third region defined by said first tri-layer laminate assembly and a third cation exchange membrane;
a fourth region defined by said third cation exchange membrane and an anode;
a fifth region defined by said first cation exchange membrane and a second trilayer laminate assembly comprising a fourth cation exchange membrane, a third anion exchange membrane, and a middle layer comprising a second water splitting catalyst layer, wherein said first cation exchange layer and said third anion exchange layer have a facing relationship;
a sixth region defined by said second tri-layer laminate assembly and a fourth anion exchange membrane;
a seventh region defined by said fourth anion exchange membrane and a cathode.

13. A process for treating water, comprising:
feeding a first water stream comprising a first concentration of alkaline earth salts and a first concentration of alkali metal salts into a first ion exchange container to produce a second water stream comprising a second concentration of alkaline earth salts and a second concentration of alkali metal salts;
wherein said second concentration of alkaline earth salts is less than said first concentration of alkaline earth salts, and wherein said second concentration of alkali metal salts is greater than said first concentration of alkali metal salts;
feeding said second water stream into an electrochemical cell
to produce a third water stream comprising third concentration of alkali metal salts;
wherein said third concentration of alkali metal salts is less than said second concentration of alkali metal salts.

14. The method of claim 13, further comprising configuring said ion exchange container to comprise a plurality of fibers each comprising a plurality of pendent functional groups, each pendent functional group comprising an alkali metal cation.

15. The method of claim 14, further comprising configuring said plurality of fibers to comprise a polymer backbone selected from the group consisting of polystyrene, polyacrylic acid, polyacrylonitrile, polymethacrylate, polyethylene, and polypropylene.

16. The method of claim 13, further comprising configuring said electrochemical cell to comprise:
a central chamber;
a cathode chamber comprising a cathode, wherein said cathode chamber is separated from said central chamber by a first water-permeable membrane; and
an anode chamber comprising an anode, wherein said anode chamber is separated from said central chamber by a second water-permeable membrane.

17. The method of claim 16, further comprising:
feeding a water output stream from said cathode chamber stream into a second ion exchange container;
feeding a water output stream from said anode chamber into a third ion exchange container; and
rotating the relative positions of the first ion exchange contain, the second ion exchange container, and the third ion exchange container.

18. The method of claim 13, further comprising configuring said first water-permeable membrane comprises a cation exchange membrane that permits passage of alkali metal cations but resists proton migration therethrough.

19. The method of claim 13, further comprising configuring said electrochemical cell to comprise a cathode chamber comprising:
a first cathode region separated from said central chamber by a first cation exchange membrane;
a second cathode region separated from said first cathode region by a second cation exchange membrane;
a third cathode region separated from said second cathode region by a third cation exchange membrane; and
a cathode disposed in said third cathode region.

20. The method of claim 19, further comprising configuring said electrochemical cell to comprise an anode chamber comprising:
a first anode region separated from said central chamber by a first anion exchange membrane;
a second anode region separated from said first anode region by a second anion exchange membrane;
a third anode region separated from said second anode region by a third anion exchange membrane;
a fourth anode region separated from said third cathode region by a fourth anion exchange membrane and
an anode disposed in said fourth anodic region.

21. The method of claim 13, further comprising configuring said electrochemical cell to comprise a central chamber comprising:
a first central region defined by a first cation exchange membrane and a first anion exchange membrane;
a second central region defined by said first anion exchange membrane and a second cation exchange membrane;
a third central region defined by said second anion exchange membrane and a second cation exchange membrane;
a fourth central region defined by said first anion exchange membrane and a third cation exchange membrane; and
a fifth central region defined by said third cation exchange membrane and a third anion exchange membrane.

22. The method of claim 21, further comprising configuring said electrochemical cell to comprise a cathode chamber comprising:
a first cathode region separated from said third central region by a said second cation exchange membrane;
a second cathode region separated from said first cathode region by a fourth cation exchange membrane;
a third cathode region separated from said second cathode region by a fifth cation exchange membrane;
a fourth cathode region separated from said third cathode region by a sixth cation exchange membrane; and
a cathode disposed in said fourth cathode region.

23. The method of claim 22, further comprising configuring said electrochemical cell to comprise an anode chamber comprising:
a first anode region separated from said central chamber by said third anion exchange membrane;
a second anode region separated from said first anode region by a fourth anion exchange membrane;
a third anode region separated from said second anode region by a fifth anion exchange membrane;
a fourth anode region separated from said third cathode region by a sixth anion exchange membrane; and
an anode disposed in said fourth anodic region.

24. The method of claim 13, further comprising configuring said electrochemical cell to comprise:
a first region defined by a first anion exchange membrane and a first cation exchange membrane;
a second region defined by said first anion exchange membrane and a first trilayer laminate assembly comprising a second cation exchange membrane, a second anion exchange membrane, and a middle layer comprising a first water splitting catalyst layer, wherein said first anion exchange layer and said second cation exchange layer have a facing relationship;
a third region defined by said first tri-layer laminate assembly and a third cation exchange membrane;
a fourth region defined by said third cation exchange membrane and an anode;
a fifth region defined by said first cation exchange membrane and a second trilayer laminate assembly comprising a fourth cation exchange membrane, a third anion exchange membrane, and a middle layer comprising a second water splitting catalyst layer, wherein said first cation exchange layer and said third anion exchange layer have a facing relationship;
a sixth region defined by said second tri-layer laminate assembly and a fourth anion exchange membrane;
a seventh region defined by said fourth anion exchange membrane and a cathode.
